(19) United States
(12) Patent Application Publication
(10) Pub. No.: US 2025/0139611 A1
(43) Pub. Date: May 1, 2025

(54) System and Methods for Implementing Blockchain Based Zero Knowledge Protocol

(71) Applicant: Accretive Technology Group, Inc., Seattle, WA (US)

(72) Inventors: Jordan Washburn, Louisville, CO (US); Greg Spillane, San Diego, CA (US)

(21) Appl. No.: 18/930,147

(22) Filed: Oct. 29, 2024

Related U.S. Application Data
(60) Provisional application No. 63/546,816, filed on Nov. 1, 2023.

(51) Int. Cl. G06Q 20/36

(52) U.S. Cl. CPC G06Q 20/3674

(57) ABSTRACT

A system and associated methods or functionality for implementing a decentralized framework that facilitates independent third-party entities to authenticate and access specific confirmed facts about individuals. This enables individuals to share validated facts without revealing extraneous details or additional information they wish to remain confidential with regards to the third-party. The disclosed protocol and systems in which it is implemented enable achieving the goal of maintaining privacy and data security while facilitating exchange of the minimal amount of information required for a specific task, to comply with a regulation, or to fulfill a request.

### CROSS REFERENCE TO RELATED APPLICATION

This application claims the benefit of U.S. Provisional Application No. 63/546,816, filed Nov. 1, 2023, entitled “System and Methods for Implementing Blockchain Based Zero Knowledge Protocol”, the disclosure of which is incorporated, in its entirety (including the Appendix) by this reference.

### BACKGROUND

Protection of private or proprietary data or information is of importance in many situations. Such data may include personal information, health related information, or employment related information, as examples. However, there are also situations in which it is necessary for a person or entity to allow access to specific data or information to be able to comply with a request or regulation. In such cases, it is desirable to allow the person or entity to approve of the release of specific data or information to a requesting party without being concerned that other data or information may also be released or allowed to be accessed without authorization.

Conventional approaches to the control and release of specific data or information have several disadvantages. These may include one or more of:
Lack of a standard way to verify data or information to be provided to a requesting entity;
Lack of a way to prevent unauthorized access to data or information that is related to (or associated with) the data or information provided to an entity but is not needed to respond to a request from the entity;
   For example, when a document providing a date of birth is provided to an entity, that document may also disclose an address or other identifying information that is not needed to respond to a request for a birthdate;
Lack of an effective mechanism to determine whether an entity has removed or deleted provided data or information, for example through use of an immutable audit trail; and
Lack of a way to identify which entities have accessed data or information.

Embodiments of the systems, apparatuses, and methods disclosed herein are directed to solving these and related problems individually and collectively.

### SUMMARY

The terms “invention,” “the invention,” “this invention,” “the present invention,” “the present disclosure,” or “the disclosure” as used herein are intended to refer broadly to all the subject matter disclosed in this document, the drawings or figures, and to the claims. Statements containing these terms do not limit the subject matter disclosed or the meaning or scope of the claims. Embodiments covered by this disclosure are defined by the claims and not by this summary. This summary is a high-level overview of various aspects of the disclosure and introduces concepts that are further described in the Detailed Description section below. This summary is not intended to identify key, essential, or required features of the claimed subject matter, nor is it intended to be used in isolation to determine the scope of the claimed subject matter. The subject matter should be understood by reference to appropriate portions of the entire specification, to any or all figures or drawings, and to each claim.

Embodiments are directed to a system and associated methods or functionality for implementing a decentralized framework that facilitates independent third-party entities to authenticate and access specific confirmed facts about individuals. This enables individuals to share validated facts without revealing extraneous details or additional information they wish to remain confidential with regards to the third-party. The disclosed protocol and systems in which it is implemented enable achieving the goal of maintaining privacy and data security while facilitating exchange of the minimal amount of information required for a specific task, to comply with a regulation, or to fulfill a request.

Although there are standard tasks requiring specific data or information and authentication (e.g., know your customer, KYC), the disclosed protocol can also be tailored for specific authentication or verification needs, such as by defining a “tag” or label that is associated with a pre-defined list of required information, data, or an authenticating entity.

Embodiments of the disclosure are directed to systems, apparatuses, and methods for implementing and using a blockchain-based zero knowledge protocol to enable the secure exposure of private data to another party. In one embodiment, a set of processes or software implemented tools are provided to enable a user to approve the release of verified data or information to a website by performing one or more of the following steps, stages, methods, operations, or functions:
Person (a user) navigates to (visits) a website;
Website requests 18+ verification (as a non-limiting example, where the website may request verification of a different fact about the user or attribute of the user) and directs the user to a registry;
Registry checks if they have a verification for the requested “fact” that the website trusts;
   If they do, then the registry asks the user if they authorize sending a tag confirming the requested information to the website (or otherwise confirming the veracity of the requested data or information); if they authorize this action, then a tag is sent and the user is redirected to the website, where they are now able to access content and/or interact with the website;
   If the registry lacks acceptable verification, then the registry asks the user if they want to be directed to an appropriate authority to verify the fact (such as that they are 18+, or other fact needing to be approved for release to the website);
      If the user agrees, then they are redirected to an approved verification site for the fact of interest that checks their age and “mints” a token/tag combination if they are 18 or over (as an example for the case of verifying the user is 18+);
   In the context of the disclosure, a token is a representative of the main item checked and the tag(s) are fact(s) that are derived from it. For example, a token might represent a driver's license (which a verifying authority would examine and verify as authentic or not) and a tag could represent specific facts or information contained within or derived from the license;
      For instance, an authority (such as a department of motor vehicles or independent verifier of the authenticity of a document) could check a driver's license which would be the token, and the following data or information could be one or more tags associated with the license:
         Full Name;
         Address;
         Date of Birth (DOB);
         Eye Color;
      In some embodiments, a tag can also be derived from a main or primary item being checked. In the driver license example, an authority may have checked the driver's license and confirmed the DOB, but instead of sharing the DOB, they created an 18+ tag (assuming the licensed person was confirmed to be 18+) and only shared that particular fact, without disclosing additional information about the user;
      In some embodiments, and depending upon the source of data and/or the information to be verified, a verifying authority may be one of:
         A governmental agency responsible for issuing a document (e.g., birth certificate, driver's license, passport, or visa);
         A non-governmental entity responsible for issuing a document (e.g., a college, bank, club, or business organization);
         An independent service provider that verifies the authenticity of a document and extracts data or information from it;
   Assuming the verifying authority was able to verify the user provided source, and “minted” an appropriate tag, the user is redirected back to the registry and the registry asks the user if they authorize sending the tag (typically as represented by an identifier known to the disclosed system/platform) to the website or other requestor of verified information—if they are, the registry sends the tag to the website and redirects the user back to the website;
      Upon receipt and processing/verification of the received tag, the website enables the user to access the content and functionality of the website.

In another possible embodiment of the disclosed and/or described process or flow, the following steps or stages may occur:
A person or entity (e.g., an individual user, organization, club, or social group) associated with specific data or information logs into a registry to identify data or information they wish to make available to a third-party;
   The person or entity identifies the data or information they wish to share with the third-party;
   The person or entity requests a “tag” from the registry to indicate the authenticity of the data or information;
      As non-limiting examples, the tag may indicate “graduated”, graduated with honors”, “qualified”, or “licensed” for the non-limiting example of an educational institution or professional organization;
The registry creates a custodian wallet associated with the person or entity;
   The registry identifies an appropriate validating or verifying authority for the data or information and provides that to the person or entity;
      The registry may maintain a list of the appropriate authorities, which may depend upon the type of document being provided by the person or entity, the issuing party for the document, or other aspect of the document or data being verified;
   In one embodiment, the custodian wallet is a location on a blockchain;
The person or entity is (re) directed to the platform or system for the appropriate validating or verifying authority;
The validating or verifying authority attempts to verify the specific data or information identified by the person or entity;
   This may occur because of the person or entity providing a document or access to specific data;
   If the data or information can be verified by the authority, the authority “mints” a token;
   The authority may apply an appropriate tag to the minted token, so that the tag is associated with the token;
      The tag may represent specific data or information associated with or derived from the token or a document/record that the token represents;
Later, the person or entity visits a website that requests verification of a specific item of data or information associated with the person or entity;
The website (re) directs the person or entity to the registry;
The person or entity logs into the registry;
   The registry accesses the custodian wallet associated with the person or entity;
      The registry checks the accessed custodian wallet to determine if it contains the data or information that the website is seeking to have verified;
      If the custodian wallet does contain the data or information that the website is seeking to have verified, the person or entity is presented with a display or interface requesting approval to share the data or information;
   If the person or entity approves/authorizes sharing of the data or information, the verified data or information is provided to the website by the registry;
      The person or entity is then directed back to the website to continue their interaction with the website.

If the person or entity does not authorize the sharing of the data or information, then the person or entity, or the website may be directed to an error or customer service message informing them that because of the lack of authorization, the registry cannot verify the requested data or information.

In one embodiment, the disclosure is directed to a system, apparatus, and method for implementing a decentralized framework that facilitates independent third-party entities (such as websites) to access specific authenticated or verified facts or information about individuals. The system or apparatus may include a set of computer-executable instructions stored in a memory or data storage component (such as one or more non-transitory computer-readable media) and one or more electronic processors or co-processors. When executed by the processors or co-processors, the instructions cause the processors or co-processors (or a device of which they are part) to perform a set of operations that implement an embodiment of the disclosed method or methods.

In one embodiment, the disclosure is directed to a set of computer-executable instructions stored in one or more non-transitory computer-readable media, wherein when the set of instructions are executed by one or more electronic processors or co-processors, the processors or co-processors (or a device of which they are part) perform a set of operations that implement an embodiment of the disclosed method or methods.

In some embodiments, the systems and methods disclosed and/or described herein may provide services or functionality through a SaaS or multi-tenant platform. The platform provides access to multiple entities, each with a separate account and associated data storage. Each account may correspond to an individual or other user, a verifying authority, a registry, or an entity (such as a website) requesting verification of an item of data or information regarding (or associated with) an individual, as non-limiting examples. Each account may access one or more services, a set of which are instantiated in their account, and which implement one or more of the methods or functions disclosed and/or described herein.

Other objects and advantages of the systems, apparatuses, and methods disclosed may be apparent to one of ordinary skill in the art upon review of the detailed description and the included figures. Throughout the drawings, identical reference characters and descriptions indicate similar, but not necessarily identical, elements. While the embodiments disclosed and/or described herein are susceptible to various modifications and alternative forms, specific embodiments are shown by way of example in the drawings and are described in detail herein. However, embodiments of the disclosure are not limited to the exemplary or specific forms described. Rather, the disclosure covers all modifications, equivalents, and alternatives falling within the scope of the appended claims.

### BRIEF DESCRIPTION OF THE DRAWINGS

Embodiments of the disclosure are described with reference to the drawings, in which:

FIGS. 1(a) and 1(b) are flowcharts or flow diagrams illustrating a method, process, set of steps, set of operations, or set of functions to enable a user to have specific data or information verified by an authorized authority, and to approve the release of the verified data or information to a website or other party, in accordance with some embodiments;

FIG. 1(c) is a block diagram and flow diagram illustrating a user and the primary entities and operations that may be present in an embodiment of the disclosure;

FIG. 1(d) is a block diagram and flow diagram illustrating a user and the primary entities and operations that may be present in an embodiment of the disclosure;

FIG. 2 is a diagram illustrating elements or components that may be present in a computing device or other form of client configured to implement a method, process, function, or operation in accordance with some embodiments; and

FIGS. 3-5 are diagrams illustrating an architecture for a multi-tenant or SaaS platform that may be used in implementing an embodiment of the systems and methods disclosed herein.

Note that the same numbers are used throughout the disclosure and figures to reference like components and features.

### DETAILED DESCRIPTION

One or more embodiments of the disclosed subject matter are described herein with specificity to meet statutory requirements, but this description does not limit the scope of the claims. The claimed subject matter may be embodied in other ways, may include different elements or steps, and may be used in conjunction with other existing or later developed technologies. The description should not be interpreted as implying any required order or arrangement among or between various steps or elements except when the order of individual steps or arrangement of elements is explicitly noted as being required.

Embodiments of the disclosed subject matter are described more fully herein with reference to the accompanying drawings, which show by way of illustration, example embodiments by which the disclosed systems, apparatuses, and methods may be practiced. However, the disclosure may be embodied in different forms and should not be construed as limited to the embodiments set forth herein; rather, these embodiments are provided so that the disclosure will satisfy the statutory requirements and convey the scope of the disclosure to those skilled in the art.

Among other forms, the subject matter of the disclosure may be embodied in whole or in part as a system, as one or more methods, or as one or more devices. Embodiments may take the form of a hardware implemented embodiment, a software implemented embodiment, or an embodiment combining software and hardware aspects. For example, in some embodiments, one or more of the operations, functions, processes, or methods disclosed and/or described herein may be implemented by a suitable processing element or elements (such as a processor, microprocessor, CPU, GPU, TPU, QPU, state machine, or controller, as non-limiting examples) that are part of a client device, server, network element, remote platform (such as a SaaS platform), an “in the cloud” service, or other form of computing or data processing system, device, or platform.

The processing element or elements may be programmed with a set of computer-executable instructions (e.g., software instructions), where the instructions may be stored on (or in) one or more suitable non-transitory computer-readable data storage elements. In some embodiments, the set of instructions may be conveyed to a user over a network (e.g., the Internet) through a transfer of instructions or an application that includes a set of instructions.

In some embodiments, the systems and methods disclosed herein may provide services or functionality through a SaaS or multi-tenant platform. The platform provides access to multiple entities, each with a separate account and associated data storage. Each account may correspond to an individual or other user, a verifying authority, a registry, or an entity (such as a website) requesting verification of an item of data or information regarding (or associated with) an individual, as non-limiting examples. Each account may access one or more services, a set of which are instantiated in their account, and which implement one or more of the methods or functions disclosed and/or described herein.

As one non-limiting example of a use case, consider a website that assists end users with career development and related tasks. The website may enable a company/employer to verify that a particular person worked there during certain dates. In this example, the website would function as a registry, an individual company would represent an authority, and a current or former employee would be the end user.

In some embodiments, one or more of the operations, functions, processes, or methods disclosed herein may be implemented by a specialized form of hardware, such as a programmable gate array, application specific integrated circuit (ASIC), or the like. Note that an embodiment of the disclosed methods may be implemented in the form of an application, a sub-routine that is part of a larger application, a “plug-in”, an extension to the functionality of a data processing system or platform, or other suitable form. The following detailed description is, therefore, not to be taken in a limiting sense.

Embodiments are directed to a system and associated methods or functionality for implementing a decentralized framework that facilitates and enables third-party entities to authenticate and/or access specific auditable facts about individuals. This enables an individual to share validated or verified facts without revealing extraneous details or additional information they wish to remain confidential with regards to the third-party.

The disclosed protocol and systems in which it is implemented enable maintaining privacy and data security while facilitating exchange of the minimal amount of information required for a specific task or to fulfill a request. In one sense, the disclosed system acts as a bridge linking individuals, verification authorities, and entities requiring/requesting verification of a fact or item of data. The disclosed protocol is tailored for use with federated registries and identity systems and operates to ensure a seamless exchange of validated facts without unnecessary exposure of an individual's data.

In one embodiment, the disclosed and/or described zero knowledge protocol (ZKP) is used in conjunction with a protocol or functionality that provides a mechanism for providing secure access to a user's wallet or data storage location on a blockchain (referred to as SWAP herein). This may be used to enable the user to provide access to and release of data or information in the wallet or storage location as part of the transfer of verified information to a requesting entity.

Among other benefits or advantages, embodiments of the disclosure overcome or remove one or more of the following disadvantages of conventional approaches to the verification or distribution of specific data or information:
Passing personal information directly to a requesting entity is problematic because:
   A user may need to do it with multiple entities and go through the same tedious process each time;
   In most cases, it is not really within a requesting entity's core competency to validate private information or to protect it;
   An entity may end up having access to extra information about a user that they don't need to know, and which could become exposed to others through a security breach;
      This provides a motivation for limiting the information known to a requesting entity to the minimum necessary to satisfy a request or requirement;
Direct integration with a verifying authority or other entity to provide specific data or information may be problematic because of one or more of:
   Both a requesting (web) site and a verifying authority/entity know the site a user has visited. The authority also knows what a person is doing online with the information. This would enable building a database of what websites people are visiting, what they are searching for, or other information users may prefer to maintain as private;
   Government agencies are more frequently serving as a verifying authority; this means they can build a registry of people who go to various types of sites (adult sites, gay sites, or marijuana sites, as examples) without invoking the relevant legal requirements (e.g., a warrant or user opt-in/permission) for obtaining that data or information;
   The information is not interoperable (i.e., able to be transferred to and used by different requesting sites without requiring a person to make a specific request for the transfer to the party in possession of the information). This roadblock may arise due to privacy concerns and/or the form the information needs to be presented in to respond to a request, with a result that a verification process may need to be performed multiple times for each unique site or requestor;
Furthermore, as mentioned, conventional approaches often have additional problematic aspects that may include one or more of:
   Lack of a standard way to verify data or information to be provided to a requesting entity;
   Lack of a way to prevent unauthorized access to data or information that is related to (or associated with) the data or information provided to an entity but is not needed to respond to a request from the entity;
      For example, when a document providing a date of birth is provided to an entity, that document may also disclose an address or other identifying information that is not needed to respond to a request for a birthdate;
   Lack of an enforceable and effective mechanism to determine whether an entity has removed or deleted provided data or information (for example, through use of an immutable audit trail, as disclosed and/or described herein); and
   Lack of a way to identify which entities have accessed data or information.
      An enforced immutable audit trail is part of a solution that addresses one or more of these problems or shortcomings of conventional approaches. Typically, relational databases or other databases may permit information to be deleted or altered, so in some embodiments, the audit trail is enforced at a policy or application level instead of at a database level.

As a non-limiting example of a situation or context in which an embodiment might be used, consider a situation in which a website (such as LinkedIn) seeks to verify a user's college or university degree. Instead of undergoing the cumbersome process of requesting and verifying an entire (or even part of a) transcript, LinkedIn simply needs confirmation of the degree's validity. In this example, a university (i.e., the registrar) may act as the validating authority. Once approved, the individual user can permit LinkedIn to access this fact. LinkedIn then only discerns the degree's validity and the credentials of the confirming authority, without accessing a full transcript which contains other information that a person may prefer to maintain as private.

Note that this information (the existence of a degree) might also provide information regarding attendance, level of a degree, or concentration area of the degree contemporaneously. To prevent the disclosure of unneeded information, embodiments provide for the creation of different “tags” or indicators for specific facts. As a non-limiting example, there could be a tag for “graduated” and/or a tag representing a specific degree type. In one embodiment, it's possible for a user to receive a series of tags from a validating authority, but only share a subset of those tags depending on the nature of the request from a requesting entity and the minimum information needed to respond to the request.

In one embodiment, the verified and auditable data is stored in a form that can be accessed through a blockchain, but the only people with access to the data are those having the “keys” associated with their wallets that are stored on the blockchain.

In one embodiment, prevention of the successful spoofing of a verifying/validating authority is addressed by both the inherent protections provided by use of a blockchain (i.e., ensuring data integrity, secure data storage and access, a desired degree of interoperability, and creating a record of data access) and the disclosed federated registry or registries. In the context of the disclosure, embodiments use blockchain as a data access, data storage, data record, and data protection mechanism, and layer registries on top of a blockchain so that information can be discovered and effectively distributed in accordance with the intentions of a user who wants to allow another person or entity to have access to their data. In one embodiment, the interoperability aspect or feature means that others can access the information without having to use a separate process or protocol.

As a non-limiting example, the following represents a possible data flow and operations that might be implemented during a use of the disclosed and/or described protocol (note that the processes involved in Asserting a fact may occur at a different time or during a different session or interaction than those involved in Ascertaining a fact, as each of those are described below):

Asserting a Fact (i.e., identifying and obtaining verification of private data or information):
1. Individuals initiate this stage by logging into a Federated Registry;
   a. User (such as a person with specific data or information they wish to securely share) identifies (a) the data or information to be shared and (b) the entities with which the data or information is to be shared (where this may occur at a later time in response to a request from an entity, such as a website, organization, or process);
2. To obtain authentication/verification (in the form of a token and/or tag) from a recognized (and presumed valid) verifying authority, individuals consult the registry to identify an appropriate verifying authority;
3. To prevent spoofing of a valid verifying authority, embodiments benefit from inherent aspects of a blockchain (e.g., resistance to alteration, a form of data storage, and support of encryption) and incorporate the use of a registry or list of validated verifying authorities for specific types or categories of information;
   a. A verifying authority can create their own “wallet” and register it with a registry, or they can create an account with the registry and have the registry create a wallet or other infrastructure associated with the authority;
   b. Typically, a manual process is used if a registry wants to communicate with a verifying authority and validate the authority, similar to how a website might use a blue checkmark;
      i. A feature of an anti-spoofing mechanism is that a verifying authority can create a unique identifier on the blockchain and broadcast that they “own” it;
   c. With these characteristics, a registry is able to function as a trusted implementation of the disclosed protocol and prevent man-in-the-middle style attacks;
4. The registry spawns a one-time custodian wallet for the individual, and redirects them to the chosen verifying authority's platform;
5. The verifying authority uses its own internal data management procedures and if the specified data or information is available, issues a “soulbound” or similar token (i.e., a publicly verifiable and non-transferable nonfungible token (NFT) that represents an individual's credentials, affiliations, or commitments, for example a transcript) to the individual's custodian wallet;
   a. Subsequent to verification/authentication of the data or information, the authority may append a distinct tag to the token (e.g., “validated”, “verified”, or “graduated with honors”, as non-limiting examples).

Ascertaining a Fact (providing specific verified data or information to another party):
1. An individual (such as a graduate of a college or university) visits a site (such as LinkedIn) and desires to validate a particular fact about themselves;
2. The site redirects the individual to a Federated Registry that oversees the list of verifying authorities (such as a college registrar for this type of data or information);
3. Upon logging into the Federated Registry, the registry retrieves the individual's custodial wallet(s) and verifies that one of the individual's wallets contains the previously issued token from the appropriate verifying authority that is associated with the sought-after facts or information;
4. If the sought-after facts or information have been validated by an appropriate authority, a screen or other display is presented to the individual to allow them to approve providing the facts, data, or information to the requesting site or entity;
   a. If the fact or information is absent from the individual's wallet(s), the registry navigates the user/individual to an appropriate verifying authority (as described above when discussing Asserting a Fact). After verification, the screen or other display is presented to the individual to allow them to authorize release of the data or information;
   b. After approval for release by the individual, the Federated Registry notifies the site or entity about the verified fact and redirects the user/individual back to the site or entity;
      i. At this point, the user/individual can continue their interaction with the site or entity, such as to access content, post content, or other form of interaction.

Embodiments of the disclosed system and associated methods may be used to enable verification and secure distribution of multiple “facts” or items of information associated with a person, an event, or a document (as non-limiting examples). In the case of a degree from an educational institution, this may include: (a) whether someone has a degree, (b) if their degree is from the University of XXX, (c) if they graduated with honors, (d) the subject matter of their degree, or (e) if they are 18 years or older (as non-limiting examples).

The disclosed system and method(s) can create a “tag” for each of these facts or assertions about a person, event, or document. This permits a user to confirm and approve release of one or more facts or items of information without sharing other facts or information (even if the unshared facts are related to those authorized to be released). This capability illustrates the power and one of the benefits of the disclosed and/or described approach.

Given a person, event, document, or other item of interest, embodiments provide a mechanism to identify multiple facts or pieces of information about the person, event, document, or item, and manage the release of one or more of those facts or pieces of information as desired. In addition to the benefits of ensuring privacy and security, this capability may be of value when it is desirable to distribute a set of facts in stages as part of a negotiation or interaction with multiple parties having different interests. This may be useful when discussing a potential joint development or acquisition situation in which it is desired to release specific information only after other information is released by another party or a partial agreement on terms has been reached.

Other non-limiting examples of potential use cases for an embodiment include validation of facts for purposes of transferring a vehicle record or history, patient records, vaccination records, or a list of manufactured parts or assembled components. Embodiments are of particular value in a situation of two groups that don't necessarily trust each other but need to do something that requires trust, such as proving identity (age verification), providing health records, or exchanging a valuable item (such as a painting or collection of books).

As mentioned, benefits and advantages of an embodiment of the disclosure include one or more of:
Protection of sensitive information;
Implementing a “right to be forgotten” to prevent unauthorized access to private data;
   The “right to be forgotten” is difficult to fully implement; however, embodiments can simplify this problem for integrators. A site that needs age verification typically/conventionally would have to take the license, then implement a “right to be forgotten” on their own and make sure they're properly handling (and deleting) data. By using a system that does this (such as an embodiment of the disclosure), integrators don't have to worry about this complication;
Auditing—for providing tracking and proof of where information was distributed and how it was handled; and
Access auditing—for end users to identify which parties accessed the distributed data or information.

In some embodiments, a set of “smart contracts” or self-executing processes are used as part of implementing the disclosed protocol and enabling the sharing of specific data or information. In the following, the indicated “contracts” represent solidity contracts¹ that the registry deploys, and/or that a verifying/validating authority can deploy. These contracts represent instructions stored on a blockchain that when executed, implement one or more of the functions or processes disclosed and/or described herein. Other types of such contracts may also be suitable for use in implementing an embodiment of the disclosure. ¹Solidity is an object-oriented, high-level programming language used to create smart contracts that automate transactions on the blockchain. After being proposed, the language was developed by contributors to the Ethereum project. The language is primarily used to create smart contracts on the Ethereum blockchain and create smart contracts on other blockchains.

Embodiments may incorporate one or more types of these contracts to enable and facilitate the transfer of data and information, and the functioning of the elements, components, and processes disclosed and/or described herein. As non-limiting examples, in some embodiments, a TrustToken is an implementation of an NFT contract (e.g., ERC721 or ERC1155). A TrustTag is a novel adaptation of an ERC721 contract that also contains information that asserts a fact, an authority badge number (the person or algorithm that asserted the fact), an instruction set on how to audit the information, and a list of people or entities allowed to access the token. In one sense, the TrustTag functions as an “endorsement” of the qualifications or state of a person. A TrustAuthority contract is a novel contract that an authenticated authority deploys (or has a registry deploy on its behalf) that helps them manage users and includes algorithms/processes that are allowed to assign tokens and assert facts. Further information regarding each contract type is provided in the following.

### Contracts/TrustToken.sol:

Type: ERC-721 compliant contract (compatible with ERC-1155 as well).

Purpose: The TrustToken contract serves as a basic and versatile representation for various pieces of information that it may be desired to tag and exchange; examples include age verification, transcript verification, and other personal data or information. The token represents something like a driver's license, which can have a list of facts associated with it (with each potentially associated with a tag, field name, or feature).

### Primary Functions & Capabilities of Contract:

mint: generate new tokens representing unique pieces of information;
burn: destroy a token, rendering the related piece of information void.

### Contracts/TrustTag.sol:

Type: ERC-721 compliant hybrid contract (provides an integration between TrustToken and TrustAuthority).

Purpose: The TrustTag functions as a bridge between a TrustToken and its associated TrustAuthority. It plays a role in the tagging of unique assets, facts, or information such as academic transcripts or supply chain items. The contract records and immortalizes interactions an authority has with a specific tag, thereby ensuring transparency and auditability.

### Primary Functions & Capabilities:

addTag: append a tag to a specific TrustToken, signifying verification of a fact or item of information by an authority;
approve: approve a particular tag;
revoke: revoke a particular tag;
addKey: add a key encrypted by an auditor's public key that can be used to decipher auditable information;
   dual encryption is a common practice for security—given some text, a person creates a key and uses that key to encrypt the text. Then a user's public key is used to encrypt that key. This enables storage of the key in a publicly accessible setting, while limiting its use;
   a user then takes their private key, decrypts the symmetric key, and then uses the symmetric key to decrypt the text;
removeKey: remove a key from the chain;
addChecksum: add a document checksum;
tagURI: get a tagURI that can be used to access public information and a directive to audit documents.

### Contracts/TrustAuthority.sol:

Type: Management Contract.

Purpose: Deployed by verifying authorities (where non-limiting examples of a verifying authority include a registrar, a motor vehicle department, a qualified jewelry appraiser, or a doctor/nurse that administers vaccinations). TrustAuthority oversees a list of approved individual validation/verification authorities. TrustTag contracts have a many-to-one (m:1) relation with TrustAuthority contracts. This contract manages and maintains the integrity of those who can approve, revoke, or add supplementary documents to tags.

### Primary Functions & Capabilities:

addAuthority: add a new authority to the approved list;
revokeAuthority: remove an authority from the approved list;
tokenURI: get a token URI for public information about an authority figure.

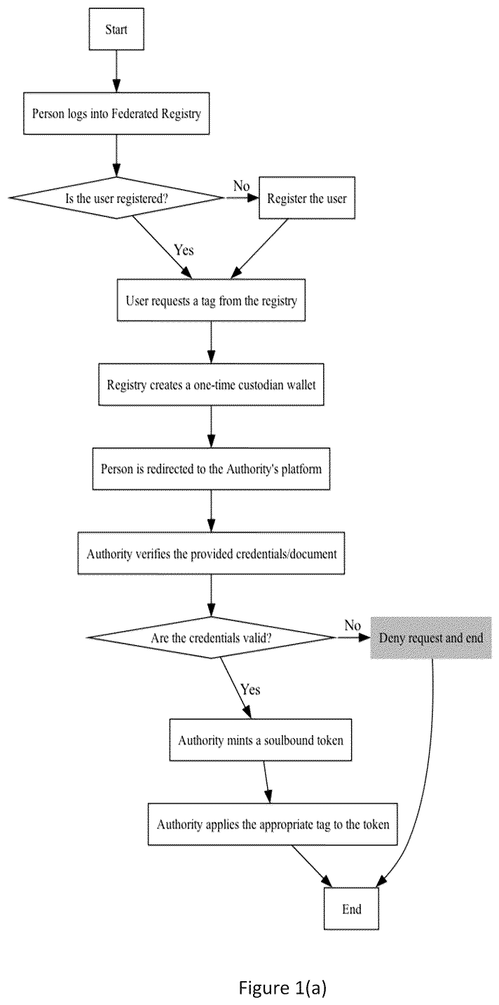

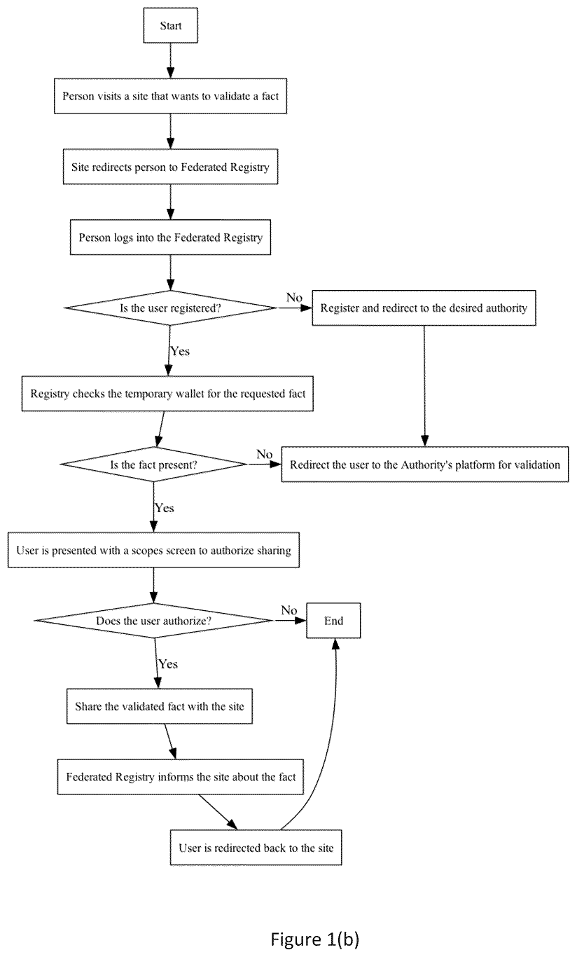

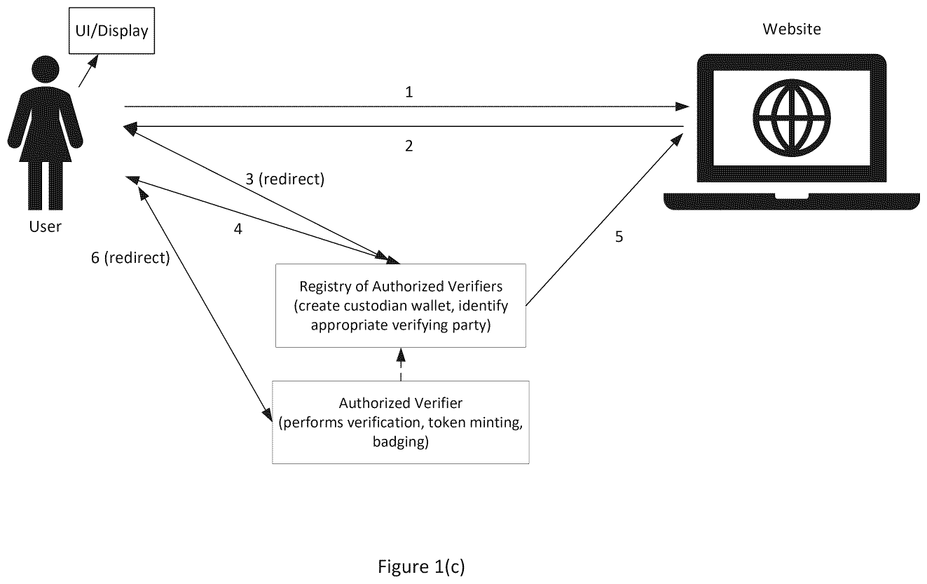

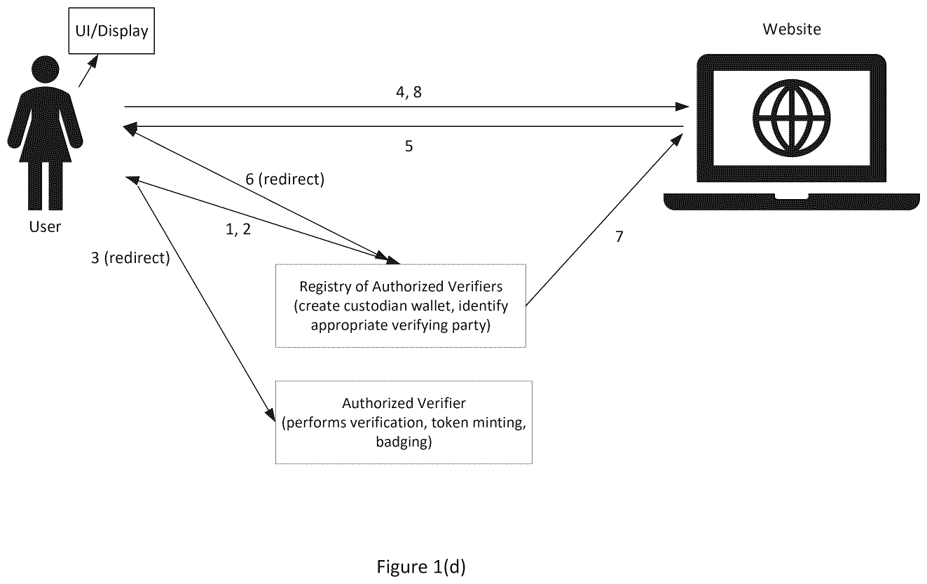

FIG. 1(c) is a block diagram and flow diagram illustrating a user and the primary entities and operations that may be present in an embodiment of the disclosure. In one embodiment, the disclosed system and process flow comprises the following entities, structures, components, or elements:
Site (Requesting Entity, such as a website):
   Role: Seeks validation of particular facts about an individual (the Person below).
   Examples: LinkedIn verifying a degree, or a building ensuring a visitor's vaccination status.
   Interactions: Utilizes the disclosed protocol to request verification, receiving only the specific fact or confirmation needed and avoiding release or providing access to unnecessary (and often private) data or information;
Person (Data Owner, User, Entity):
   Role: Possesses specific facts or credentials, encapsulated as tokens by a Registry or Verifying Authority.
   Example: An individual with a degree or a status for a specific vaccination.
   Interactions: Inputs their credentials into the disclosed and/or described system and authorizes sharing of specific facts with a specified entity or requestor (such as a website);
   The Person, User, or Entity (e.g., a company, organization, department, or club) is associated with one or more items of information or data, and desires to allow access to that information or data in a secure manner to an indicated party (such as a website);
      May have access to a user-interface or display to authorize the release of a specific verified item of information or data to a requesting website or other entity;
Authority (Authorized Verifier or Validator of the Person, User, or Entity's item of data or information):
   Role: Validates/Verifies and labels facts related to the Person, User, or Entity.
   Example: University registrar, department of motor vehicles, health institution, doctor's office.
   Interactions: Evaluates provided (or otherwise accessible) credentials or data, affixes tags to tokens, and manages the tags as required (such as by implementing identity or other data management through a third-party application).
Federated Registry of Authorized Verifiers:
   Role: Endorses sites and verifying/validating authorities, liaises with federated identity management, and orchestrates the interactions amongst Persons (e.g., Users, Entities), verifying/validating authorities, and requesting entities (such as a website, application, or service).
      As a non-limiting example—a system or platform assisting a Person/User to coordinate with a verification or authentication authority to procure tags/tokens and enable a requesting site or organization to receive verification of specific facts or information;
   Interactions: Facilitates authentication of specific user facts or information, guides users to relevant authority platforms to obtain tags/tokens and may provide a protocol (referred to herein as SWAP²) for presenting the fact or information to a site or requestor. ²The Secure Wallet Access Protocol (SWAP) is a decentralized solution for handling personal information. Utilizing blockchain and private keys, SWAP guarantees that only users have access to their data, allowing detailed control over data sharing. In some embodiments, users may use the SWAP protocol to authenticate and share information without divulging any data outside of the minimum facts necessary to achieve their objective. A further and more detailed description of the SWAP protocol is contained in PCT International Application No. PCT/IB2023/056704, titled “Improving Online Community and Privacy For Non-Fungible Token (NFT) Token Holders, filed Jun. 28, 2023, and claiming priority to U.S. Patent Application Ser. No. 63/356,144, filed Jun. 28, 2022, sections of which are included herein, and the entire contents of both of which are incorporated herein by this reference to the extent permissible.

In one embodiment, the disclosed and/or described entities, their roles, and functions involved may include (as suggested by the block diagram and flow illustrated in FIG. 1(c)):
Person navigates to (visits) a website (step or stage 1);
Website (or application or service, as further examples) requests 18+ verification (or verification of another fact) and directs the user to a registry (step or stage 2);
Registry checks if they have a verification for the fact that the website trusts (step or stage 3);
   If they do, then the registry asks the user if they authorize sending a tag confirming the requested information to the website; if they do authorize, then the tag is sent and user is redirected to website, where they are now able to access content or features (step or stage 4, followed by 5);
   If the registry lacks acceptable verification, the registry asks the user if they want to go to a verifying authority to verify they are 18+ (or the other specific fact needing confirmation/verification);
   If the user does want to be directed to a verifying authority, the user is redirected to an approved verification site for the specific fact requested, and that authority checks their age and “mints” a token/tag combination if they are 18+ (as an example for the case of verifying that a user is 18 or over) (step or stage 6);
   User is redirected back to the registry and the registry asks the user if they authorize sending that tag to the website (or application or service, as further examples)—if they do, it redirects them back to the website (similar to steps or stages 4 and 5).

FIG. 1(d) is a block diagram and flow diagram illustrating a user and the primary entities and operations that may be present in an embodiment of the disclosure. In one embodiment, the disclosed system and process flow comprises the following entities, structures, components, or elements (which are the same as those described with reference to FIG. 1(c)):
Site (Requesting Entity, such as a website, application, or service):
   Role: Seeks validation of particular facts about an individual (the Person below).
   Examples: LinkedIn verifying a degree, or a building ensuring a visitor's vaccination status.
   Interactions: Utilizes the disclosed protocol to request verification, receiving only the specific fact or confirmation needed and avoiding release or providing access to unnecessary (and often private) data or information;
Person (Data Owner, User, Entity):
   Role: Possesses specific facts or credentials, encapsulated as tokens by a Registry or Verifying Authority.
   Example: An individual with a degree or a status for a specific vaccination.
   Interactions: Inputs their credentials into the disclosed and/or described system and authorizes sharing of specific facts with a specified entity or requestor (such as a website);
   The Person, User, or Entity (e.g., a company, organization, department, or club) is associated with one or more items of information or data, and desires to allow access to that information or data in a secure manner to an indicated party (such as a website);
      May have access to a user-interface or display to authorize the release of a specific verified item of information or data to a requesting website or other entity;
Authority (Authorized Verifier or Validator of the Person, User, or Entity's item of data or information):
   Role: Validates/Verifies and labels facts related to the Person, User, or Entity.
   Example: University registrar, department of motor vehicles, health institution, doctor's office.
   Interactions: Evaluates provided (or otherwise accessible) credentials or data, affixes tags to tokens, and manages the tags as required (such as by implementing identity or other data management through a third-party application).
Federated Registry of Authorized Verifiers:
   Role: Endorses sites and verifying/validating authorities, liaises with federated identity management, and orchestrates the interactions amongst Persons (e.g., Users, Entities), verifying/validating authorities, and requesting entities (such as a website, application, or service).
      As a non-limiting example—a system or platform assisting a Person/User to coordinate with a verification or authentication authority to procure tags/tokens and enable a requesting site or organization to receive verification of specific facts or information;
   Interactions: Facilitates authentication of specific user facts or information, guides users to relevant authority platforms to obtain tags/tokens and may provide a protocol (referred to herein as SWAP) for presenting the fact or information to a site or requestor.

In one embodiment, the processing flow illustrated in FIG. 1(d) may include the following set of steps, stages, functions, or operations:
A person or entity associated with specific data or information logs into a registry to identify specific data or information they wish to make available to a third-party (as suggested by step or stage 1 in the diagram);
   The person or entity identifies the data or information they wish to share with the third-party;
   The person or entity requests a “tag” from the registry to indicate the authenticity of the data or information;
      As non-limiting examples, the tag may indicate “graduated”, graduated with honors “, “qualified”, or “licensed”;
The registry creates a custodian wallet associated with the person or entity;
   The registry identifies an appropriate validating or verifying authority for the data or information to the person or entity (as suggested by step or stage 2);
The person or entity is (re) directed to the platform for the appropriate validating or verifying authority (as suggested by step or stage 3);
The validating or verifying authority attempts to verify the specific data or information identified by the person or entity;
   If the data or information can be verified by the authority, the authority “mints” a token;
   The authority applies the appropriate tag to the minted token, so that the tag is associated with the token;
Later, the person or entity visits a website that requests verification of a specific item of data or information associated with the person or entity (as suggested by step or stage 4);
   As mentioned herein, an application or service (as further non-limiting examples) may also or instead request verification of a fact or information associated with a user;
The website (re) directs the person or entity to the registry (as suggested by steps or stages 5 and 6);
The person or entity logs into the registry;
   The registry accesses the custodian wallet associated with the person or entity;
      The registry checks the accessed custodian wallet to determine if it contains the data or information that the website is seeking to have verified;
      If the custodian wallet does contain the data or information that the website is seeking to have verified, the person or entity is presented with a display or interface requesting approval to share the data or information (as suggested by the presentation of the UI or display);
   If the person or entity approves/authorizes sharing of the data or information, the verified data or information is provided to the website by the registry (as suggested by step or stage 7);
The person or entity is directed back to the website (or application or service, as further examples) to continue their interaction with the website (as suggested by step or stage 8).

FIGS. 1(a) and 1(b) are flowcharts or flow diagrams illustrating a method, process, set of steps, set of operations, or set of functions to enable a user to have specific data or information verified by an authorized authority, and to approve the release of the verified data or information to a website or other party, in accordance with some embodiments.

FIG. 1(a) illustrates a set of steps or stages that may be used by a person or entity to interact with a registry to identify a suitable verifying authority and use that authority to verify an item of information or data associated with the person or entity and apply a “tag” if relevant to the verified item.

As shown in the figure, in one embodiment, a process for an authority company to “author” a fact may include the following steps, stages, operations, or functions:
Person logs into a federated registry, a trustworthy identity application that stores a connection between a person and their information/data and serves as a kind of escrow for exchanging information;
User states that they're looking to validate a fact/request a tag, so this is like “I am claiming aim 18+;
The registry creates a one-time use custodian wallet—this is also called a pseudo-anonymous wallet for blockchain. This wallet holds the new fact;
The registry then redirects the user to the authority with a unique id—the authority in this example case is a company that verifies the fact and then tells the registry to write it to the custodian wallet;
The authority mints a soulbound token—so after the fact has been validated (yes, the person is 18+), the authority creates a document that they put in the wallet tied to the user;
The authority tags the token—they “write” the fact on that document so at the end of this process the registry knows about the user and this new document that the authority wrote and can inform others that this user is 18+.

FIG. 1(b) illustrates a set of steps or stages that may be used by a person or entity to interact with a website that wants to verify the item of information or data associated with the person or entity. As shown in the figure, in one embodiment, a process for a website to validate a fact about an end user (where the end user has already had the fact verified) may include the following steps, stages, operations, or functions:
Site redirects person to federated registry with a request for the fact—so the website redirects user to the trusted identity application that stores the facts;
Registry checks to see if the user has that fact—if they do its going to ask them if they want to go back to the website and send this information. If they don't, then the process of FIG. 1(a) may be executed.

In one embodiment, a user may obtain access to the disclosed and/or described functions, operations, or processes via direct access through a remote procedure call (RPC). This allows a user to interact directly through method calls with a blockchain using remote procedure calls and open-source libraries (such as web.js). Another approach is accessing through a third-party service that provides the ability for users to interact with a registry, in some cases using a UI built on top of the blockchain to make it easier to interact with the blockchain scans (e.g., polygonscan/etherscan may also or instead be used to audit specific transactions or contracts, as examples).

As mentioned, in some embodiments, a protocol referred to herein as “SWAP” may be used to provide a zero knowledge (ZK) method that enables a user to send a fact to a third party (e.g., a website) without other parts of their identity being compromised, including but not limited to other identifiers such as wallet identifiers or user identifications, biometrics, and/or other facts or attributes about themselves. The ZK method may be fully traceable or trackable such that applicable data (e.g., connections between transactions) may be provided to an auditor, for example.

While the use of SWAP enables an exchange of information, it does not completely address the need to provide identity or partial data protection in some situations. This is achieved as part of an embodiment of the present disclosure using a specific implementation (trust contracts) that protects identity and includes a registry to negotiate the exchange of factual data that has been validated by an authority and can be audited and tracked.

SWAP is configured to hide permanent record information behind a federated service so that a user never has the permanent record information on a device or computer (e.g., a smartphone, laptop, or tablet, as examples) that may be lost. SWAP can be run as a federated module anywhere. It can be user owned so the user has control over their own data, or SWAP can be run by a third-party service provider. Because the source data is blockchain, SWAP instances are interoperable and share the same source data as well, allowing users to use any instance.

In some embodiments, SWAP may be configured to use single use wallets that store tagged tokens representing generalizable and documented facts. In these instances, wallets can be audited to verify the facts source data but will not compromise other user information. SWAP can also be run using ZK proofs and other best practices configured to prevent compromising a single use wallet address. However, this implementation may disable or compromise one or more of the disclosed benefits which provide auditability and traceability. For example, if a user has a valid driver's license, SWAP may be used with a ZK proof to prove the existence of the driver's license. But to provide auditability, SWAP can be configured to provide a single use wallet that can trace the history of that particular driver's license.

SWAP may be configured to tie single use wallets together with a changeable private pseudonym to continue to protect and obscure user data. In addition, SWAP may be configured to enable levels of encryption around individualized user data that have different levels of usability and security. For example, the highest level of security may require passphrases from an end user along with two factor authentication and server-side keys to decrypt factual data (thereby making recovery more challenging). The lowest level of security may require only server-side keys (thereby making recovery easier).

In one embodiment of SWAP, to implement SWAP a utility NFT interface is configured to effectuate operations including requesting approval from the wallet owner for a specific token or that token's metadata. Upon receiving approval from the wallet owner, the utility NFT interface facilitates receiving an authorization grant code. The authorization grant code is presented to a wallet access server. An access token is received along with the specific token or token metadata from the wallet access server. The utility NFT interface and SWAP are configured such that only the specific token or token metadata and nothing else is shared. The access token is presented to the wallet access server to request permitted resources. Thereafter, the permitted resources are received from the wallet access server. The utility NFT interface is configured such that the token is verifiable via the blockchain.

Note that the utility NFT interface may be configured such that the application (such as a website) does not have access to the token ID. In this situation, the application does not have permission to see the token data. In one embodiment, the application does not have access to the wallet address. In this situation, the application does not have permission to see the contents of the digital wallet. In one embodiment, the access token can be used by the application to interact with the specific token metadata until the access token is revoked by the wallet owner. The utility NFT interface may be configured such that the application has continued access to the specific token metadata until that access is denied by the wallet owner.

The utility NFT interface may be configured such that the SWAP protocol enables a third-party application to obtain limited access to an HTTP service on behalf of a wallet owner. This can be used to facilitate reading and interacting with scoped token metadata and actions without compromising the wallet address.

Wallets contain the tokens that a user owns. By identifying the person that owns a wallet one can learn a lot of information about the user without their consent, including but not limited to places they have visited, brands they are interested in, social status, general wealth, and more. As wallets are filled with more and more assets, they can be used to construct more elaborate profiles of people and potentially infringe to a greater extent on privacy rights. Ownership of tokens informs third parties about a user's otherwise private preferences. As a result, third parties preferably should only have access to selective tokens in the digital wallet and only with the user's consent.

SWAP, as facilitated by the utility NFT interface, is a protocol that allows an application to request that a user authorize access to view individualized metadata about tokens from their wallet without gaining access to the token ID, the contract address, or the wallet address. These pieces of information can be used to uniquely identify the user and extract the rest of the information from their wallet, thereby invading their privacy.

An example use case for SWAP is an application requiring checking if the end user holds a token in their wallet that grants them access to a virtual concert. Normally, this problem is solved by the application being provided a signed transaction that proves a user owns a wallet address. Once the user proves ownership over the wallet, the application can look in the wallet, find an appropriate token, and verify they are allowed in.

Instead, SWAP enables the application to ask the user, “Will you attend this event?” The user can then consent to answering the question without sending contract addresses, wallet addresses, or token IDs to the application. Using SWAP, a user can send a fact (e.g., token metadata in this example) to a third party (e.g., a website associated with the virtual concert) without other parts of their identity being compromised, including but not limited to an identifier such as a wallet identifier or user identification, biometrics, and/or other facts or attributes about a user that might be stored in a digital wallet.

Assume an example of a digital wallet containing Tokens X, Y, and Z that are owned by the wallet owner and stored in their digital wallet. As a non-limiting example, a third-party application wants access to Token Y, which is for a virtual concert. Upon authorization by the wallet owner, the utility NFT interface and the SWAP protocol are configured such that, instead of showing everything in the digital wallet, including Tokens X, Y, and Z, only the metadata of Token Y is made accessible to the third-party application. As a result, the third-party application will know that the wallet owner is attending the virtual concert but will not be privy to the contents of Tokens X or Z, or even the full contents of Token Y, as only Token Y metadata is passed on to the third-party application.

As a non-limiting example of how a SWAP protocol could be implemented by the utility NFT interface, the following steps or stages may occur:
a requesting third-party application makes a request to a wallet owner asking for a specific set of information scoped to their application needs and benefits;
   here, “scoped” is used in the permissions sense that applies to modern authentication systems. When you receive permission to do something, “scoping” means that you get permission to do that specific thing and nothing else. As an example, in the context of a use case for an embodiment of the disclosure, one might be able to see the 18+ verification, but not the specific age, the date of birth, or the person's address;
in response, the wallet owner directed to a wallet access server and presented with a screen that notifies them of the information held within the scoped request;
   upon the wallet owner's approval, a short-lived authorization grant code is created and passed back to the application;
the application then uses the grant code to request scoped information and an access token from the wallet access server;
the wallet access server validates the grant code and if valid, responds with metadata about the tokens of the wallet owner (or in some cases, a specific token), and sends a scoped access token that can be used for future requests about those resources;
the application then uses the scoped access token to request permitted resources from the wallet access server;
the wallet access server accepts requests with scoped access tokens and verifies the access token—if valid, the server provides the requested permitted resources to the third-party application and creates, updates, or modifies appropriate data;
   the third-party application can continue to use the access token for permitted interactions until it expires or is revoked by the wallet owner.

In this context, scopes are filterable identifiers that are identified by the third-party application and issued to the wallet owner when requesting information. Scopes include higher level projects that map to an array of contract addresses, individual contract addresses, as well as specific benefits or permissions. An example scope would be translated to: “The application server is requesting permission to read information and send chat messages about tickets to a Steve A concert on Dec. 12, 2022.”

An authorization grant is the credentialed access submitted by a wallet owner to the wallet access server to prove that they own the wallet in question. The proof is accomplished by signing a transaction with the wallet owner's private key and verified with the wallet owner's public key. Once this proof is obtained, an access token is established between the wallet access server and the wallet owner that persists the authorization for that user to the wallet.

An authorization code is created by a wallet access server and distributed to third-party applications at directive of the wallet owner. An application first requests a scoped authorization code. After authorizing with the wallet access server, the wallet owner approves the authorization code, and the access server sends it to the third-party application. This access code is then used to establish a scoped access token between the application and the wallet access server.

As a non-limiting example of the aforementioned permitted resources, a musician can work with a third-party ticketing platform to offer free tickets to owners of a certain NFT. The token holder would go to the third-party ticketing platform and connect their wallet to verify ownership of the NFT. Thereafter, SWAP validates ownership and passes authentication back to the ticketing platform without disclosing the wallet address. Finally, the ticket is granted. In this case, the permitted resources would be validating ownership of the NFT.

Access tokens are used by third-party applications to issue requests to wallet access servers on the wallet owner's behalf. Access tokens can be revoked from the wallet access servers by the wallet owner to remove access from the third-party application.

As described herein, SWAP is configured to hide permanent record information behind a federated service so that a user never has the permanent record information on a device or computer (e.g., a smartphone, a laptop, or tablet). Blockchain may be used as part of a trusted, interoperable, decentralized data store that can be accessed by anyone. A federated architecture is a loosely coupled cooperating set of services. In the disclosed examples, SWAP is a federated service that fosters the transfer of a decentralized fact from one service to another without compromising a user's information.

A real-world example of this could be a vaccination card or medical record. In this scenario, there may be an asserter of the fact (the administrator of the vaccine), there may be people that care about the fact (e.g., a school or other organization), and there is a federated service that sits in between to facilitate the transfer (e.g., a piece of paper). SWAP serves as a service or protocol in the place of the paper and controls the information more tightly, so a date of birth or other vital information is not unintentionally provided.

SWAP can be operated as a federated module on a server and/or other computing device. It can be user controlled so the user has control over their own data, or SWAP can be run by a service. It can also be moved; being able to be moved means that an instance of SWAP can facilitate the transfer of these facts. It is an interoperable layer that leverages decentralized data on the blockchain, so any entity can run it. For example, Google could run a server that facilitates SWAP, or Amazon could operate the server, or a user could operate a device executing SWAP. Further, performing certain operations or functions on one federated provider does not mean SWAP is beholden to that federated provider. If a user decides they no longer trust that provider to facilitate this exchange of information, the provider may be changed.

In some embodiments, SWAP may be configured to use single use wallets to store facts so that the wallets can be audited but not in a way that will compromise other user information. A single use wallet is the same as every other wallet. However, most wallets hold multiple assets, from currency to tokens, and have long histories of transactions. A single use wallet may be created, a token is added, and then it is never used again or tied to anything else. This enables the history of the token to be tracked in isolation.

Using the example of a driver's license, the wallet contains the entire history of that one particular event and nothing else (thus providing traceability and privacy). In these examples, the token also points to an array of encrypted documents and holds a list of users that are allowed to access those documents. This enables a person or company (such as a driver's license owner or the DMV) to grant temporary access to others so that they can access, decrypt, and audit the supporting documentation. As an example, this enables government agencies to further inspect things that have been asserted as facts to verify their accuracy.

SWAP can be utilized with ZK proofs and other best practices configured to prevent compromising a single use wallet address. ZK proofs concern proving a fact without conveying any information about that fact. For the example of a vaccination, a first entity can ask a user for data or information that only a holder of that information would be able to answer. The user is then able to use their vaccination/medical record to create a response to that challenge or request. The first entity, trusting the advanced cryptographic algorithms utilized in an embodiment, then trusts that the response is valid without seeing the proof.

However, in some situations, this may disable one or more of the benefits which provide auditability and traceability for some facts. For example, if a user has a valid driver's license, SWAP may be used with a ZK proof to prove the existence of the driver's license. In this situation, to provide auditability, SWAP can be configured to provide a single use wallet that can trace the history of that particular driver's license.

As mentioned, SWAP may be configured to tie multiple single use wallets together with a changeable private pseudonym to continue to protect and obscure use data. In this case, a single use wallet encompasses all of the information about one thing, such as a driver's license and all of the related facts. On the blockchain, that wallet is not tied in any way to any other transaction, so the owner of that wallet is not publicly discoverable.

The federated module stores a pseudonym for the real user that only they know and that can be changed at any point in time. This means that in order for a snooper/attacker to create an entire history for a person, they would have to hack the federated module in three different ways (and possibly steal the persons phone and their password) to gather all of the wallet addresses to compose a complete history of publicly viewable statements about that person. In addition, as mentioned, SWAP is configured to enable levels of encryption around individualized user data that have different levels of usability and security. For example, the highest level of security may require passphrases from an end user along with two factor authentication and server-side keys to decrypt factual data, while the lowest level of security may require only server-side keys.

As disclosed and/or described herein, embodiments may use a combination of SWAP and trusted tokens or contracts to provide a secure means of exchanging private information, while limiting the risk of releasing more than the minimum amount of data or information necessary to respond to a request.

With regards to distinguishing TRUST from SWAP, SWAP is a foundational/lower-level protocol focused on secure information exchange. Its primary focus is to ensure that wallet addresses and thereby identities are not compromised when information is shared. Trust Contracts are a protocol and set of contracts focused on the auditable and immutable recording of factual information done by an authority and applied to an individual.

As an example, Trust would be used for the Department of Motor Vehicles creating a driver's license and certifying it (asserting the person is 18+ in a way that has provenance and a chain of record to identify who did it, when, and stored information along with it). SWAP would be used for something like a driver license owner sharing factual information on a license between two parties without compromising or releasing other information that might be derived from the license.

Embodiments leverage Trust Contracts and SWAP to freely exchange verified information. Trust contracts can be used without the SWAP, but it may result in the system not being able to maintain anonymity. The usage of SWAP with Trust Contracts ensures security and privacy during information transfer without creating an opportunity for spoofing or compromising identities.

As non-limiting examples of the use of Trust contracts and the SWAP protocol together, consider the following:

### Verifying a Professional Credential

1. A licensing board (Authority in TRUST) issues a license token to a professional;
2. The board adds tags to the token for license status, expiration date, etc.;
3. When a client needs to verify the license, they initiate a verification request;
4. TRUST uses SWAP to securely communicate between the professional and the client:
   The client's application requests access to the professional's license information;
   The professional approves the request through their wallet;
   SWAP generates an authorization code, which the client's application uses to obtain a scoped access token;
   The client's application uses this token to request the specific license information;
5. SWAP ensures that only the relevant license information is shared, without exposing the professional's wallet address or other personal data;
6. The professional proves their license is valid without exposing personal information;
7. The client can verify the authenticity of the license through the blockchain, without accessing any unnecessary data.

### Academic Transcript Verification

1. A university (Authority in TRUST) issues a degree token to a graduate;
2. The university adds tags verifying graduation, GPA, and other relevant academic information;
3. An employer requests transcript verification;
4. TRUST leverages SWAP for secure communication between the graduate and employer:
   The employer's application requests access to the graduate's academic credentials;
   The graduate approves the request through their wallet;
   SWAP generates an authorization code, which the employer's application uses to obtain a scoped access token;
   The employer's application uses this token to request specific academic information;
5. SWAP ensures that only the relevant academic information is shared, without exposing the graduate's wallet address or full transcript details;
6. The graduate proves their degree credentials without revealing unnecessary information;
7. The employer can verify the authenticity of the academic credentials through the blockchain, maintaining the graduate's privacy.

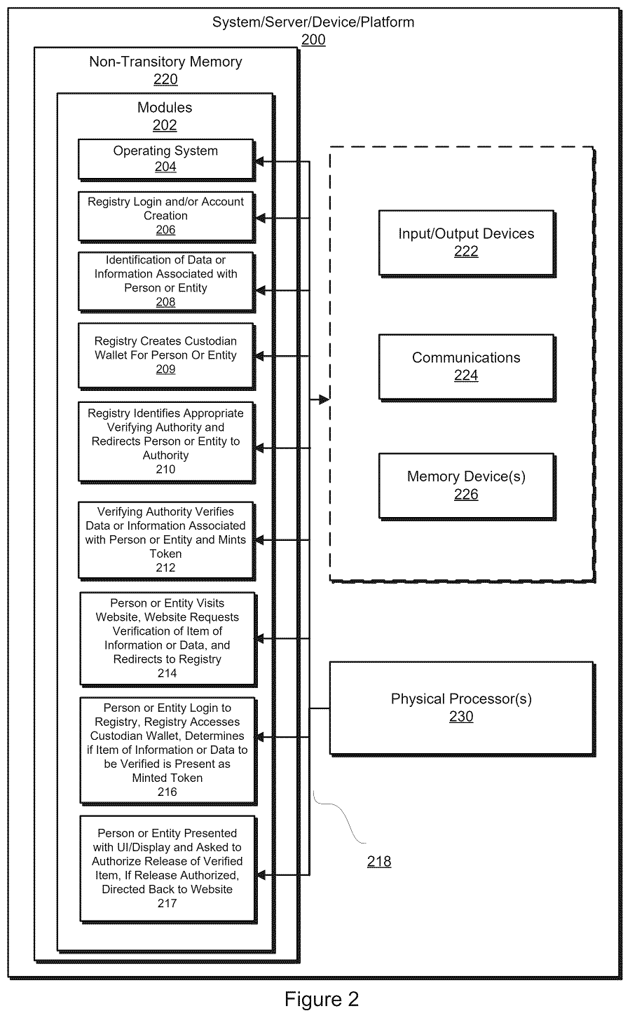

As a non-limiting example, FIG. 2 is a diagram illustrating elements or components that may be present in a computing device or system 200 configured to implement a method, process, function, or operation in accordance with some embodiments. As noted, in some embodiments, the disclosed and/or described system and methods (or a portion thereof) may be implemented in the form of an apparatus or platform that includes a processing element and a set of executable instructions stored in (or on) a non-transitory computer-readable memory or data storage component. The executable instructions may be part of a software application and arranged into a software architecture.

In general, an embodiment of the disclosed methods or processing (in whole or in part) may be implemented using a set of software instructions that are designed to be executed by one or more suitably programmed processing elements (such as a GPU, TPU, CPU, QPU, state machine, microprocessor, processor, controller, or other computing device). In a complex application or system such instructions are typically arranged into “modules” with each such module typically performing a specific task, process, function, or operation. The entire set of modules may be controlled or coordinated in their operation by an operating system (OS) or other form of organizational platform.

The application modules and/or sub-modules may include any suitable computer-executable code or set of instructions (e.g., as would be executed by a suitably programmed processor, microprocessor, or CPU), such as computer-executable code corresponding to a programming language. For example, programming language source code may be compiled into computer-executable code. Alternatively, or in addition, the programming language may be an interpreted programming language such as a scripting language.

As mentioned, each module may contain instructions which when executed by a programmed processor or co-processors cause an apparatus (such as a client device or server) to perform the specific function or functions. In some embodiments, the disclosed system may include both a client device and a remote server or platform. A module may contain instructions that are performed (in whole or in part) by a client device, a server or platform, or by both.

As shown in FIG. 2, system 200 may represent a client, server, or other form of computing or data processing device. Modules 202 each contain a set of executable instructions, where when the set of instructions is executed by a suitable electronic processor (such as that indicated in the figure by “Physical Processor(s) 230”), system (or device) 200 operates to perform a specific process, operation, function, or method.

Modules 202 may contain one or more sets of instructions for performing a method or function described with reference to the Figures, and the descriptions of the functions and operations provided in the specification. The modules may include those illustrated but may also include a greater number or fewer number than those illustrated. Further, the modules or the computer-executable instructions that are contained in a module or modules may be executed by the same processor or by more than a single processor.

Modules 202 are stored in a (non-transitory) memory 220, which typically includes an Operating System module 204 that contains instructions used (among other functions) to access and control the execution of the instructions contained in other modules. The modules 202 in memory 220 are accessed for purposes of transferring data and executing instructions by use of a “bus” or communications line 218, which also serves to permit processor(s) 230 to communicate with the modules for purposes of accessing and executing a set of instructions. Bus or communications line 218 also permits processor(s) 230 to interact with other elements of system 200, such as input or output devices 222, communications elements 224 for exchanging data and information with devices external to system 200, and additional memory devices 226.

Each application module or sub-module may correspond to a specific function, method, process, or operation that is implemented by the module or sub-module. Each module or sub-module may contain a set of computer-executable instructions that when executed by a programmed processor or co-processors cause the processor or co-processors (or a device or devices in which they are contained) to perform the specific function, method, process, or operation.

With reference to FIG. 2, in some embodiments, the implemented steps, stages, elements, components, functions, methods, processes, or operations may include those used to perform one or more aspects of the disclosed and/or described system and methods. In this regard, an embodiment may include one or more of the following functions, capabilities, processes, or operations (each of which may be implemented in a client device and/or a remote server or one or more of the entities or elements illustrated in FIGS. 1(c) and 1(d)), depending upon the content being processed and the resulting output):
A person or entity associated with specific data or information logs into a registry (and/or creates an account) to identify specific data or information they wish to make available to a third-party (as suggested by module 206 in the diagram);
The person or entity identifies the data or information they wish to share with the third-party (as suggested by module 208);
   The person or entity may request a “tag” from the registry to indicate the authenticity of the data or information;
   As non-limiting examples, the tag may indicate “graduated”, graduated with honors”, “qualified”, or “licensed”;
The registry creates a custodian wallet associated with the person or entity (as suggested by module 209);
The registry identifies an appropriate validating or verifying authority for the data or information to the person or entity (as suggested by module 210);
   The person or entity is (re) directed to the platform for the appropriate validating or verifying authority;
The validating or verifying authority attempts to verify the specific data or information identified by the person or entity (as suggested by module 212);
   If the data or information can be verified by the authority, the authority “mints” a token;
   If applicable, the authority applies an appropriate tag to the minted token, so that the tag is associated with the token;
      Whenever the registry creates a tag/token, it inserts it into an anonymous custodian wallet, so this creates a single use container for the token/tag that will only hold that token and the relevant tags;
      The registry then stores a link between the federated user identity and the anonymous custodian wallet;
      When a user comes in from a federated identity, such as “login with google” it uses their unique id to pull facts about them;
Later, the person or entity visits a website that requests verification of a specific item of data or information associated with the person or entity (as suggested by module 214);
   The website (re) directs the person or entity to the registry;
   As mentioned herein, the entity requesting verification may also or instead be an application or service, as further non-limiting examples;
The person or entity logs into the registry, and the registry accesses the custodian wallet associated with the person or entity (as suggested by module 216);
   The registry checks the accessed custodian wallet to determine if it contains the data or information that the website is seeking to have verified;
   If the custodian wallet does contain the data or information that the website is seeking to have verified, the person or entity is presented with a display or interface requesting approval to share the data or information (as suggested by the presentation of the UI or display indicated by Module 217);
If the person or entity approves/authorizes sharing of the data or information, the verified data or information is provided to the website by the registry (as suggested by module 217);
   The person or entity is directed back to the website to continue their interaction with the website (as suggested by module 217).

As mentioned, in some embodiments, the systems and methods disclosed and/or described herein may provide services through a Software-as-a-Service (Saas) or multi-tenant platform. The platform provides access to multiple entities, each with a separate account and associated data storage. Each account may correspond to an individual or other user, a verifying authority, a registry, or an entity (such as a website) requesting verification of an item of data or information regarding (or associated with) an individual, as non-limiting examples. Each account may access one or more services, a set of which are instantiated in their account, and which implement one or more of the methods or functions disclosed and/or described herein.

In one example embodiment, a Federated Registry may operate or be associated with a Software-as-a-Service (Saas) or multi-tenant platform as part of administering the disclosed and/or described protocol.

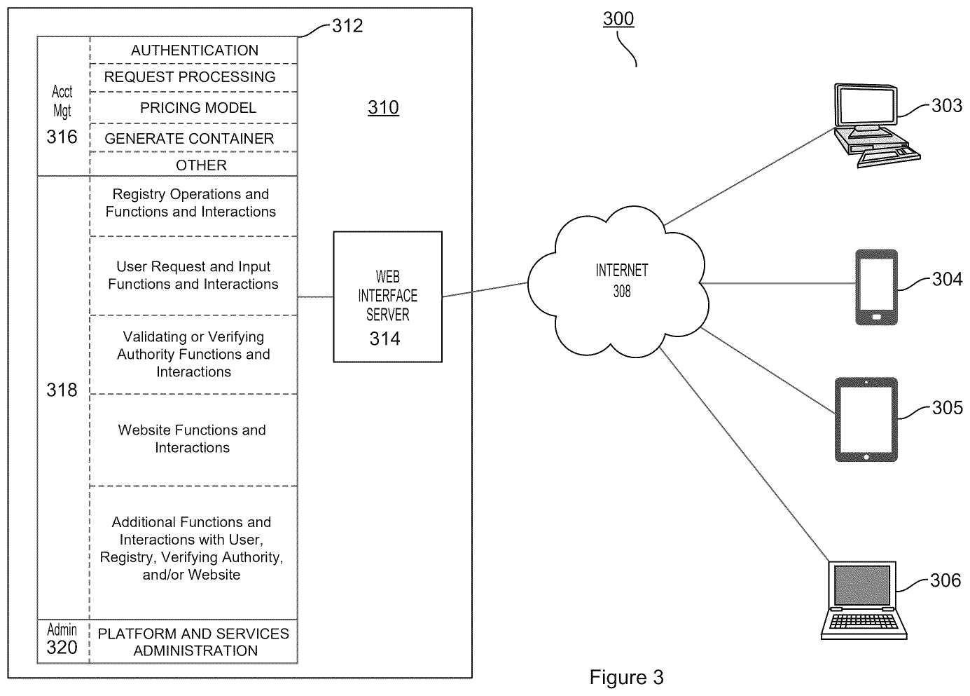

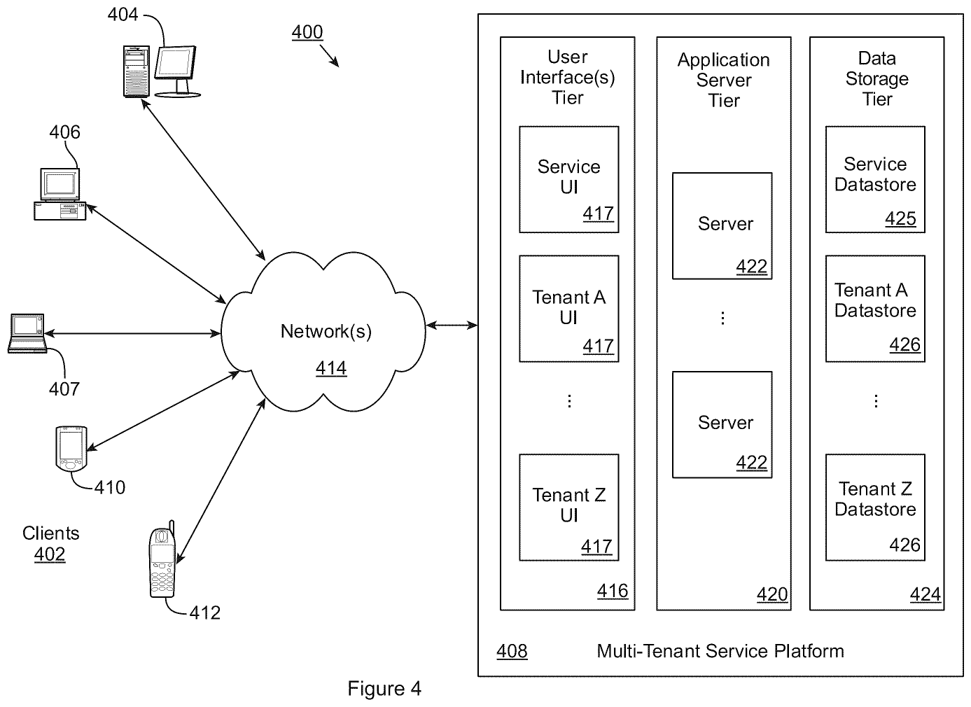

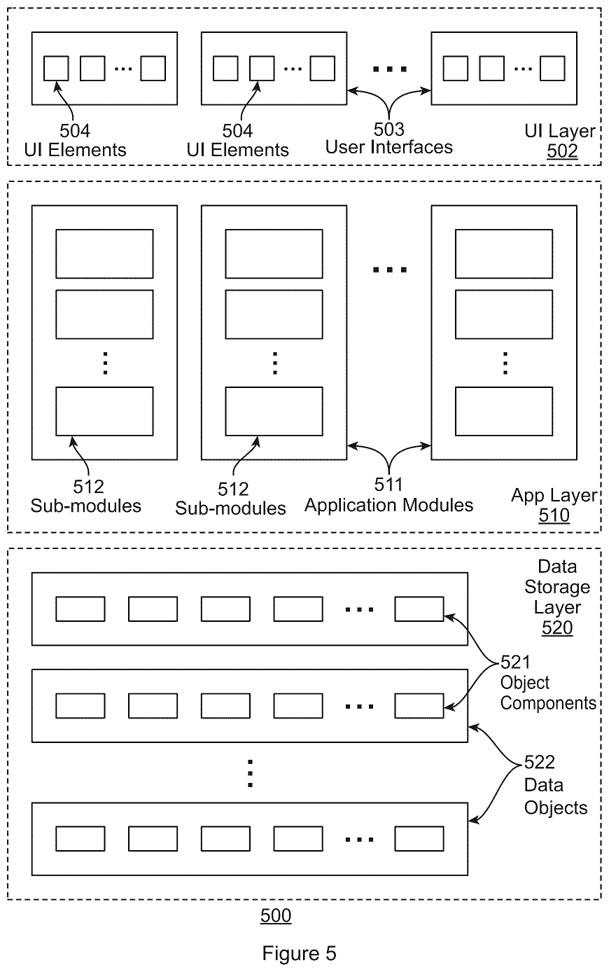

FIG. 3 is a diagram illustrating a SaaS system with which an embodiment may be implemented. FIG. 4 is a diagram illustrating elements or components of an example operating environment with which an embodiment may be implemented. FIG. 5 is a diagram illustrating additional details of the elements or components of the multi-tenant distributed computing service platform of FIG. 4, with which an embodiment may be implemented.

In some embodiments, the system or service(s) disclosed and/or described herein may be implemented as micro-services, processes, workflows, or functions performed in response to requests. The micro-services, processes, workflows, or functions may be performed by a server, data processing element, platform, or system. In some embodiments, the services may be provided by a service platform located “in the cloud”. In such embodiments, the platform is accessible through APIs and SDKs.

The functions, processes and capabilities disclosed and/or described herein and with reference to one or more of the Figures may be provided as microservices within the platform. The interfaces to the microservices may be defined by REST and GraphQL endpoints. An administrative console may allow users or an administrator to securely access the underlying request and response data, manage accounts and access, and in some cases, modify the processing workflow or configuration.

Note that although FIGS. 3-5 illustrate a multi-tenant or SaaS architecture that may be used for the delivery of business-related or other applications and services to multiple accounts/users, such an architecture may also be used to deliver other types of data processing services and provide access to other applications. For example, such an architecture may be used to provide services and functionality as disclosed and/or described herein.

FIG. 3 is a diagram illustrating a system 300 in which an embodiment of the disclosure may be implemented or through which an embodiment of the services disclosed and/or described herein may be accessed. In accordance with the advantages of an application service provider (ASP) hosted business service system (such as a multi-tenant data processing platform), users of the services may comprise individuals, businesses, stores, or organizations, as non-limiting examples. In general, a client device having access to the Internet may be used to provide a request for a service. Users interface with the service platform across the Internet 308 or another suitable communications network or combination of networks. Non-limiting examples of suitable client devices include desktop computers 303, smartphones 304, tablet computers 305, or laptop computers 306.

System 310, which may be hosted by a third party, may include a set of services 312 and a web interface server 314, coupled as shown in FIG. 3. It is to be appreciated that either or both of services 312 and the web interface server 314 may be implemented on one or more different hardware systems and components, even though represented as singular units in FIG. 3. Services 312 may include one or more functions or operations for implementing all or a portion of the Trusted contracts and SWAP protocol disclosed and/or described herein.

In some embodiments, the set of applications or services available to a user may include one or more that perform the functions and methods disclosed and/or described herein. As examples, in some embodiments, the set of applications, functions, operations or services made available through the platform or system 310 may include:
account management services 316, such as
   a process or service to authenticate a person or entity requesting access to and use of the services provided by the disclosed system and methods (such as credentials, proof of purchase, or verification that the customer has been authorized by a company to use the services provided by the platform);
   a process or service to receive a request for a service provided through the platform (such as verification and release of an item of information or data associated with a person or entity);
   an optional process or service to generate a price for the requested service or a charge against a service contract;
   a process or service to generate a container or instantiation of the requested processes for a user/customer, where the instantiation may be customized for a particular company; and
   other forms of account management services;
a set of processes or services 318, such as a process or service for:
   enabling a person or entity associated with specific data or information to log into a registry (and/or create an account) to identify specific data or information they wish to make available to a third-party;
      in some implementations, a SaaS platform may be used to operate such a registry;
   enabling the person or entity to identify the data or information they wish to share with the third-party;
   enabling the person or entity to request a “tag” from the registry to indicate the authenticity (or a characteristic) of the data or information;
      as non-limiting examples, the tag may indicate “graduated”, graduated with honors”, “qualified”, or “licensed”;
   enabling or assisting the registry to create a custodian wallet associated with the person or entity;
   enabling or assisting the registry to identify an appropriate validating or verifying authority for the data or information to the person or entity;
   enabling the person or entity to be (re) directed to the platform for the appropriate validating or verifying authority;
   enabling or assisting the validating or verifying authority to verify the specific data or information identified by the person or entity;
      if the data or information can be verified by the authority, enabling the authority to “mint” a token;
      the authority may apply an appropriate tag to the minted token, so that the tag is associated with the token;
   enabling or assisting a website visited by the person or entity (or an application or service, as further non-limiting examples) and which desires verification of an item of information or data associated with the person or entity to (re) direct the person or entity to the registry, where the registry then performs the following;
      the person or entity logs into the registry, and the registry accesses the custodian wallet associated with the person or entity;
      the registry checks the accessed custodian wallet to determine if it contains the data or information that the website is seeking to have verified;
      if the custodian wallet does contain the data or information that the website is seeking to have verified, the person or entity is presented with a display or interface requesting approval to share the data or information;
   enabling or assisting the verified data or information to be provided to the website (or application or service, as examples) by the registry if the person or entity approves/authorizes sharing of the data or information;
      the person or entity is directed back to the website (or application or service) to continue their interaction with the website;
administrative services 320, such as
   a process or services to enable the provider of the disclosed and/or described services and/or the platform to administer and configure the processes and services provided to users.

The platform or system shown in FIG. 3 may be hosted on a distributed computing system made up of at least one, but typically multiple, “servers.” A server is a physical computer dedicated to providing data storage and an execution environment for one or more software applications or services intended to serve the needs of the users of other computers that are in data communication with the server, for instance via a public network such as the Internet. The server, and the services it provides, may be referred to as the “host” and the remote computers, and the software applications running on the remote computers being served may be referred to as “clients.” Depending on the computing service(s) that a server offers it could be referred to as a database server, data storage server, file server, mail server, print server, or web server (as examples).

FIG. 4 is a diagram illustrating elements or components of an example operating environment 400 in which an embodiment of the disclosure may be implemented. As shown, a variety of clients 402 incorporating and/or incorporated into a variety of computing devices may communicate with a multi-tenant service platform 408 through one or more networks 414. For example, a client may incorporate and/or be incorporated into a client application (e.g., software) implemented or executed at least in part by one or more of the computing devices.

Examples of suitable computing devices include personal computers, server computers 404, desktop computers 406, laptop computers 407, notebook computers, tablet computers or personal digital assistants (PDAs) 410, smart phones 412, cell phones, and consumer electronic devices incorporating one or more computing device components (such as one or more electronic processors, microprocessors, central processing units (CPU), or controllers). Examples of suitable networks 414 include networks utilizing wired and/or wireless communication technologies and networks operating in accordance with any suitable networking and/or communication protocol (e.g., the Internet).

The distributed computing service/platform (which may also be referred to as a multi-tenant data processing platform) 408 may include multiple processing tiers, including a user interface tier 416, an application server tier 420, and a data storage tier 424. The user interface tier 416 may maintain multiple user interfaces 417, including graphical user interfaces and/or web-based interfaces. The user interfaces may include a default user interface for the service to provide access to applications and data for a user or “tenant” of the service (depicted as “Service UI” in the figure), as well as one or more user interfaces that have been specialized/customized in accordance with user specific requirements (e.g., represented by “Tenant A UI”, . . . , “Tenant Z UI” in the figure, and which may be accessed via one or more APIs)).

The default user interface may include user interface components enabling a tenant to administer the tenant's access to and use of the functions and capabilities provided by the service platform. This may include accessing tenant data, launching an instantiation of a specific application, or causing the execution of specific data processing operations, as non-limiting examples. Each application server or processing tier 422 shown in the figure may be implemented with a set of computers and/or components including computer servers and processors, and may perform various functions, methods, processes, or operations as determined by the execution of a software application or set of instructions. The data storage tier 424 may include one or more data stores, which may include a Service Data store 425 and one or more Tenant Data stores 426. Data stores may be implemented with a suitable data storage technology, including structured query language (SQL) based relational database management systems (RDBMS).

Service Platform 408 may be multi-tenant and may be operated by an entity to provide multiple tenants with a set of business-related or other data processing applications, data storage, and functionality. For example, the applications and functionality may include providing web-based access to the functionality used by a business to provide services to end-users, thereby allowing a user with a browser and an Internet or intranet connection to view, enter, process, or modify certain types of information. Such functions or applications are typically implemented by one or more modules of software code/instructions that are maintained on and executed by one or more servers 422 that are part of the platform's Application Server Tier 420. As noted with regards to FIG. 3, the platform system shown in FIG. 4 may be hosted on a distributed computing system made up of at least one, but typically multiple, “servers.”

As mentioned, rather than build and maintain such a platform or system themselves, a business may utilize a platform or system provided by a third party. A third party may implement a business system/platform as described in the context of a multi-tenant platform, where individual instantiations of a business' data processing workflow (such as the architecture and processes as disclosed and/or described herein) are provided to users, with each company/business representing a tenant of the platform. One advantage to such multi-tenant platforms is the ability for each tenant to customize their instantiation of the data processing workflow to that tenant's specific business needs or operational methods. Further, each tenant may be a business or entity that uses the multi-tenant platform to provide business services and functionality to multiple users.

FIG. 5 is a diagram illustrating additional details of the elements or components of the multi-tenant distributed computing service platform of FIG. 4, with which an embodiment of the disclosure may be implemented. In general, an embodiment may be implemented using a set of software instructions that are designed to be executed by a suitably programmed processing element (such as a CPU, microprocessor, processor, controller, or computing device). In a complex system such instructions are typically arranged into “modules” with each such module performing a specific task, process, function, or operation. The entire set of modules may be controlled or coordinated in their operation by an operating system (OS) or other form of organizational platform.

The example architecture 500 of a multi-tenant distributed computing service platform illustrated in FIG. 5 includes a user interface layer or tier 502 having one or more user interfaces 503. Examples of such user interfaces include graphical user interfaces and application programming interfaces (APIs). Each user interface may include one or more interface elements 504. For example, users may interact with interface elements to access functionality and/or data provided by application and/or data storage layers of the example architecture. Examples of graphical user interface elements include buttons, menus, checkboxes, drop-down lists, scrollbars, sliders, spinners, text boxes, icons, labels, progress bars, status bars, toolbars, windows, hyperlinks, and dialog boxes. Application programming interfaces may be local or remote and may include interface elements such as parameterized procedure calls, programmatic objects, and messaging protocols.

The application layer 510 may include one or more application modules 511, each having one or more associated sub-modules 512. Each application module 511 or sub-module 512 may correspond to a function, method, process, or operation that is implemented by the module or sub-module (e.g., a function or process related to providing data processing and other services to a user of the platform). Such function, method, process, or operation may include those used to implement one or more aspects of the disclosed system and methods, such as for one or more of the processes or functions disclosed and/or described with reference to the specification and Figures:
enabling a person or entity associated with specific data or information to log into a registry (and/or create an account) to identify specific data or information they wish to make available to a third-party;
   in some implementations, a SaaS platform may be used to operate such a registry;
enabling the person or entity to identify the data or information they wish to share with the third-party;
enabling the person or entity to request a “tag” from the registry to indicate the authenticity of the data or information;
   as non-limiting examples, the tag may indicate “graduated”, graduated with honors”, “qualified”, or “licensed” (or another characteristic);
enabling or assisting the registry to create a custodian wallet associated with the person or entity;
enabling or assisting the registry to identify an appropriate validating or verifying authority for the data or information to the person or entity;
enabling the person or entity to be (re) directed to the platform for the appropriate validating or verifying authority;
enabling or assisting the validating or verifying authority to verify the specific data or information identified by the person or entity;
   if the data or information can be verified by the authority, enabling the authority to “mint” a token;
   the authority may apply an appropriate tag to the minted token, so that the tag is associated with the token;
enabling or assisting a website visited by the person or entity (or an application or service, as further non-limiting examples) and which desires verification of an item of information or data associated with the person or entity to (re) direct the person or entity to the registry, where the registry then performs the following;
   the person or entity logs into the registry, and the registry accesses the custodian wallet associated with the person or entity;
   the registry checks the accessed custodian wallet to determine if it contains the data or information that the website is seeking to have verified;
   if the custodian wallet does contain the data or information that the website is seeking to have verified, the person or entity is presented with a display or interface requesting approval to share the data or information;
enabling or assisting the verified data or information to be provided to the website (or application or service, as examples) by the registry if the person or entity approves/authorizes sharing of the data or information;
the person or entity is directed back to the website (or application or service) to continue their interaction with the website.

The application modules and/or sub-modules may include any suitable computer-executable code or set of instructions (e.g., as would be executed by a suitably programmed processor, microprocessor, or CPU), such as computer-executable code corresponding to a programming language. For example, programming language source code may be compiled into computer-executable code. Alternatively, or in addition, the programming language may be an interpreted programming language such as a scripting language. Each application server (e.g., as represented by element 422 of FIG. 4) may include each application module. Alternatively, different application servers may include different sets of application modules. Such sets may be disjoint or overlapping.

The data storage layer 520 may include one or more data objects 522 each having one or more data object components 521, such as attributes and/or behaviors. For example, the data objects may correspond to tables of a relational database, and the data object components may correspond to columns or fields of such tables. Alternatively, or in addition, the data objects may correspond to data records having fields and associated services. Alternatively, or in addition, the data objects may correspond to persistent instances of programmatic data objects, such as structures and classes. Each data store in the data storage layer may include each data object. Alternatively, different data stores may include different sets of data objects. Such sets may be disjoint or overlapping.

Note that the example computing environments depicted in FIGS. 3-5 are not intended to be limiting examples. Further environments in which an embodiment may be implemented in whole or in part include devices (including mobile devices), software applications, systems, apparatuses, networks, SaaS platforms, laaS (infrastructure-as-a-service) platforms, or other configurable components that may be used by multiple users for data entry, data processing, application execution, or data review (as non-limiting examples).

This disclosure includes the following embodiments and clauses:

1. A method, comprising:
receiving at a registry, an identification of specific data or information a person or entity wants to make available to a third-party;
creating a custodian wallet associated with the person or entity;
identifying an appropriate validating or verifying authority for the specific data or information;
redirecting the person or entity to a validating or verifying authority;
receiving verification of the specific data or information identified by the person or entity from the validating or verifying authority;
minting a token representing the data or information verified by the validating or verifying authority;
adding the minted token to the custodian wallet associated with the person or entity;
receiving a request from a website for verification of the specific data or information associated with the person or entity;
redirecting the person or entity to the registry, wherein upon login by the person or entity, the registry accesses the custodian wallet associated with the person or entity and checks the accessed custodian wallet to determine if it contains a token for the data or information that the website is seeking to have verified and if the custodian wallet contains the token for the data or information that the website is seeking to have verified, presenting the person or entity with a display or interface requesting approval to share the data or information; and
providing the token for the verified data or information to the website by the registry and directing the person or entity back to the website to continue their interaction with the website if the person or entity approves sharing of the data or information.

2. The method of clause 1, wherein the data or information relates to the age of the person, the educational level of the person, the location of the person, a license of the person, a characteristic of the person, a status of the entity, or a characteristic of the entity.

3. The method of clause 1, wherein the custodian wallet is created on a public blockchain.

4. A method comprising:
determining that a person has navigated to or visited a website;
in response, the website requesting verification of a specific fact regarding the person, and directing the person to a registry;
determining if the registry has a verification for the specific fact that the website will accept;
the registry asking the user if they authorize providing a tag confirming the requested information to the website if the registry does have the verification;
the registry providing the tag to the website and redirecting the person to website if the person authorizes sending the tag to the website, whereby the person is able to access content on the website;
the registry asking the person if they want to be directed to an authority to verify the specific fact, if the registry lacks acceptable verification;
redirecting the person to an approved verification site for the specific fact that verifies the fact and mints a token and tag combination if the fact can be verified;
redirecting the person back to the registry;
sending the tag to the website if the person authorizes the registry to provide the tag to the website; and
redirecting the person to the website if they authorize the registry to provide the tag to the website.

5. A system, comprising:
one or more electronic processors configured to execute a set of computer-executable instructions; and
the set of computer-executable instructions stored in one or more non-transitory computer-readable media, wherein when executed, the instructions cause the one or more electronic processors to:
receive at a registry, an identification of specific data or information a person or entity wants to make available to a third-party;
create a custodian wallet associated with the person or entity;
identify an appropriate validating or verifying authority for the data or information;
redirect the person or entity to the platform for the appropriate validating or verifying authority;
verify the specific data or information identified by the person or entity;
mint a token if the data or information is verified by the authority;
apply an appropriate tag to the minted token if applicable;
add the minted token to the custodian wallet associated with the person or entity;
receive a visit at a website from the person or entity, wherein the website requests verification of the specific data or information associated with the person or entity;
redirect the person or entity to the registry, wherein upon login by the person or entity, the registry accesses the custodian wallet associated with the person or entity and checks the accessed custodian wallet to determine if it contains a token for the data or information that the website is seeking to have verified and if the custodian wallet contains the token for the data or information that the website is seeking to have verified, presenting the person or entity with a display or interface requesting approval to share the data or information; and
provide the token for the verified data or information to the website by the registry and directing the person or entity back to the website to continue their interaction with the website if the person or entity approves sharing of the data or information.

6. One or more non-transitory computer-readable media including a set of computer-executable instructions that when executed by one or more programmed electronic processors, cause the processors to:
receive at a registry, an identification of specific data or information a person or entity wants to make available to a third-party;
create a custodian wallet associated with the person or entity;
identify an appropriate validating or verifying authority for the data or information;
redirect the person or entity to the platform for the appropriate validating or verifying authority;
verify the specific data or information identified by the person or entity;
mint a token if the data or information is verified by the authority;
apply an appropriate tag to the minted token if applicable;
add the minted token to the custodian wallet associated with the person or entity;
receive a visit at a website from the person or entity, wherein the website requests verification of the specific data or information associated with the person or entity;
redirect the person or entity to the registry, wherein upon login by the person or entity, the registry accesses the custodian wallet associated with the person or entity and checks the accessed custodian wallet to determine if it contains a token for the data or information that the website is seeking to have verified and if the custodian wallet contains the token for the data or information that the website is seeking to have verified, presenting the person or entity with a display or interface requesting approval to share the data or information; and
provide the token for the verified data or information to the website by the registry and directing the person or entity back to the website to continue their interaction with the website if the person or entity approves sharing of the data or information.

The present invention as disclosed and/or described herein can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

In some embodiments, certain of the methods, models or functions disclosed and/or described herein may be embodied in the form of a trained neural network, where the network is implemented by the execution of a set of computer-executable instructions or representation of a data structure. The instructions may be stored in (or on) a non-transitory computer-readable medium and executed by a programmed processor or processing element. The set of instructions may be conveyed to a user through a transfer of instructions or an application that executes a set of instructions over a network (e.g., the Internet). The set of instructions or an application may be utilized by an end-user through access to a SaaS platform or a service provided through such a platform.

The software components, processes, or functions disclosed and/or described in this application may be implemented as software code to be executed by a processor using a suitable computer language such as Python, Java, JavaScript, C, C++, or Perl using conventional or object-oriented techniques. The software code may be stored as a series of instructions or commands in (or on) a non-transitory computer-readable medium, such as a random-access memory (RAM), a read only memory (ROM), a magnetic medium such as a hard-drive, or an optical medium such as a CD-ROM. In this context, a non-transitory computer-readable medium is a medium suitable for the storage of data or an instruction set aside from a transitory waveform. Such computer readable medium may reside on or within a single computational apparatus and may be present on or within different computational apparatuses within a system or network.

According to one example implementation, the term processing element or processor, as used herein, may be a central processing unit (CPU), or conceptualized as a CPU (such as a virtual machine). In this example implementation, the CPU or a device in which the CPU is incorporated may be coupled, connected, and/or in communication with one or more peripheral devices, such as a display. In another example implementation, the processing element or processor may be incorporated into a mobile computing device, such as a smartphone or tablet computer.

The non-transitory computer-readable storage medium referred to herein may include a number of physical drive units, such as a redundant array of independent disks (RAID), a flash memory, a USB flash drive, an external hard disk drive, thumb drive, pen drive, key drive, a High-Density Digital Versatile Disc (HD-DV D) optical disc drive, an internal hard disk drive, a Blu-Ray optical disc drive, or a Holographic Digital Data Storage (HDDS) optical disc drive, synchronous dynamic random access memory (SDRAM), or similar devices or forms of memories based on similar technologies. Such computer-readable storage media allow the processing element or processor to access computer-executable process steps and application programs, stored on removable and non-removable memory media, to off-load data from a device or to upload data to a device. As mentioned, with regards to the embodiments disclosed and/or described herein, a non-transitory computer-readable medium may include a structure, technology, or method apart from a transitory waveform or similar medium.

Example embodiments of the disclosure are described herein with reference to block diagrams of systems, and/or flowcharts or flow diagrams of functions, operations, processes, or methods. One or more blocks of the block diagrams, or one or more stages or steps of the flowcharts or flow diagrams, and combinations of blocks in the block diagrams and combinations of stages or steps of the flowcharts or flow diagrams may be implemented by computer-executable program instructions. In some embodiments, one or more of the blocks, or stages or steps may not necessarily need to be performed in the order presented or may not necessarily need to be performed at all.

The computer-executable program instructions may be loaded onto a general-purpose computer, a special purpose computer, a processor, or other programmable data processing apparatus to produce a specific example of a machine. The instructions that are executed by the computer, processor, or other programmable data processing apparatus create means for implementing one or more of the functions, operations, processes, or methods disclosed and/or described herein. The computer program instructions may be stored in (or on) a computer-readable memory that may direct a computer or other programmable data processing apparatus to function in a specific manner, such that the instructions stored in (or on) the computer-readable memory produce an article of manufacture including instruction means that when executed implement one or more of the functions, operations, processes, or methods disclosed and/or described herein.

While embodiments of the disclosure have been described in connection with what is presently considered to be the most practical approach and technology, the embodiments are not limited to the disclosed implementations. Instead, the disclosed implementations are intended to include and cover modifications and equivalent arrangements included within the scope of the appended claims. Although specific terms are employed herein, they are used in a generic and descriptive sense only and not for purposes of limitation.

This written description uses examples to describe one or more embodiments of the disclosure, and to enable a person skilled in the art to practice the disclosed approach and technology, including making and using devices or systems and performing the associated methods. The patentable scope of the disclosure is defined by the claims, and may include other examples that occur to those skilled in the art. Such other examples are intended to be within the scope of the claims if they have structural and/or functional elements that do not differ from the literal language of the claims, or if they Include structural and/or functional elements with insubstantial differences from the literal language of the claims.

All references, including publications, patent applications, and patents, cited herein are hereby incorporated by reference to the same extent as if each reference was individually and specifically indicated to be incorporated by reference and/or was set forth in its entirety herein.

The use of the terms “a” and “an” and “the” and similar references in the specification and in the claims are to be construed to cover both the singular and the plural, unless otherwise indicated herein or clearly contradicted by context. The terms “having,” “including,” “containing” and similar references in the specification and in the claims are to be construed as open-ended terms (e.g., meaning “including, but not limited to,”) unless otherwise noted.

Recitation of ranges of values herein are intended to serve as a shorthand method of referring individually to each separate value inclusively falling within the range, unless otherwise indicated herein, and each separate value is incorporated into the specification as if it were individually recited herein. Method steps or stages disclosed and/or described herein may be performed in any suitable order unless otherwise indicated herein or clearly contradicted by context.

The use of examples or exemplary language (e.g., “such as”) herein, is intended to illustrate embodiments of the disclosure and does not pose a limitation to the scope of the claims unless otherwise indicated. No language in the specification should be construed as indicating any non-claimed element as essential to each embodiment of the disclosure.

As used herein (i.e., the claims, figures, and specification), the term “or” is used inclusively to refer items in the alternative and in combination.

Different arrangements of the elements, structures, components, or steps illustrated in the figures or described herein, as well as components and steps not shown or described are possible. Similarly, some features and sub-combinations are useful and may be employed without reference to other features and sub-combinations. Embodiments have been described for illustrative and not for restrictive purposes, and alternative embodiments may become apparent to readers of the specification. Accordingly, the disclosure is not limited to the embodiments described in the specification or depicted in the figures, and modifications may be made without departing from the scope of the appended claims.

That which is claimed is:

1. A method, comprising:
receiving at a registry, an identification of data or information a person or entity wants to make available to a third-party;
creating a custodian wallet associated with the person or entity;
identifying a validating or verifying authority for the data or information;
redirecting the person or entity to the identified validating or verifying authority, wherein the validating or verifying authority operates to validate or verify the data or information identified by the person or entity, mints a token when the data or information is validated or verified by the authority, and provide the minted token to the registry;
adding the minted token to the custodian wallet associated with the person or entity;
receiving a request for verification of the data or information associated with the person or entity from a requesting entity;
accessing the custodian wallet associated with the person or entity and determining if it contains a token for the data or information that has been requested to be verified by the requesting entity;
presenting the person or entity with a display or interface requesting approval to share the data or information if the custodian wallet contains the token for the data or information that has been requested to be verified by the requesting entity; and
providing the token for the verified data or information to the requesting entity and enabling the person or entity to continue interacting with the requesting entity if the person or entity approves sharing of the data or information.

2. The method of claim 1, wherein the data or information relates to the age of the person, the educational level of the person, the location of the person, a license of the person, a characteristic of the person, a status of the entity, or a characteristic of the entity.

3. The method of claim 1, wherein the custodian wallet is created on a public blockchain.

4. The method of claim 1, wherein the validating or verifying authority for the data or information is determined by the registry and is one or more of a professional organization, a government entity, or a service provider.

5. The method of claim 1, wherein the requesting entity is one of a website, an organization, an application, or a service.

6. The method of claim 1, wherein accessing the custodian wallet associated with the person or entity is performed in accordance with a zero-knowledge protocol.

7. The method of claim 1, wherein the minted token is associated with a tag or indicator specifying the verified data or information, and further wherein the tag or indicator is provided to the requesting entity.

8. The method of claim 1, wherein the person or entity interacts with the requesting entity prior to interacting with the registry and is redirected to the registry by the requesting entity.

9. A system, comprising:
one or more electronic processors configured to execute a set of computer-executable instructions; and
the set of computer-executable instructions stored in one or more non-transitory computer-readable media, wherein when executed, the instructions cause the one or more electronic processors to:
receive at a registry, an identification of data or information a person or entity wants to make available to a third-party;
create a custodian wallet associated with the person or entity;
identify a validating or verifying authority for the data or information;
redirect the person or entity to the identified validating or verifying authority, wherein the validating or verifying authority operates to validate or verify the data or information identified by the person or entity, mints a token when the data or information is validated or verified by the authority, and provide the minted token to the registry;
add the minted token to the custodian wallet associated with the person or entity;
receive a request for verification of the data or information associated with the person or entity from a requesting entity;
access the custodian wallet associated with the person or entity and determining if it contains a token for the data or information that has been requested to be verified by the requesting entity;
present the person or entity with a display or interface requesting approval to share the data or information if the custodian wallet contains the token for the data or information that has been requested to be verified by the requesting entity; and
provide the token for the verified data or information to the requesting entity and enabling the person or entity to continue interacting with the requesting entity if the person or entity approves sharing of the data or information.

10. The system of claim 9, wherein the data or information relates to the age of the person, the educational level of the person, the location of the person, a license of the person, a characteristic of the person, a status of the entity, or a characteristic of the entity.

11. The system of claim 9, wherein the custodian wallet is created on a public blockchain.

12. The system of claim 9, wherein the validating or verifying authority for the data or information is determined by the registry and is one or more of a professional organization, a government entity, or a service provider.

13. The system of claim 9, wherein the requesting entity is one of a website, an organization, an application, or a service.

14. The system of claim 9, wherein accessing the custodian wallet associated with the person or entity is performed in accordance with a zero-knowledge protocol.

15. The system of claim 9, wherein the minted token is associated with a tag or indicator specifying the verified data or information, and further wherein the tag or indicator is provided to the requesting entity.

16. The system of claim 9, wherein the person or entity interacts with the requesting entity prior to interacting with the registry and is redirected to the registry by the requesting entity.

17. One or more non-transitory computer-readable media including a set of computer-executable instructions that when executed by one or more programmed electronic processors, cause the processors to:
receive at a registry, an identification of data or information a person or entity wants to make available to a third-party;
create a custodian wallet associated with the person or entity;
identify a validating or verifying authority for the data or information;
redirect the person or entity to the identified validating or verifying authority, wherein the validating or verifying authority operates to validate or verify the data or information identified by the person or entity, mints a token when the data or information is validated or verified by the authority, and provide the minted token to the registry;
add the minted token to the custodian wallet associated with the person or entity;
receive a request for verification of the data or information associated with the person or entity from a requesting entity;
access the custodian wallet associated with the person or entity and determining if it contains a token for the data or information that has been requested to be verified by the requesting entity;
present the person or entity with a display or interface requesting approval to share the data or information if the custodian wallet contains the token for the data or information that has been requested to be verified by the requesting entity; and
provide the token for the verified data or information to the requesting entity and enabling the person or entity to continue interacting with the requesting entity if the person or entity approves sharing of the data or information.

18. The one or more non-transitory computer-readable media of claim 17, wherein the data or information relates to the age of the person, the educational level of the person, the location of the person, a license of the person, a characteristic of the person, a status of the entity, or a characteristic of the entity.

19. The one or more non-transitory computer-readable media of claim 17, wherein the custodian wallet is created on a public blockchain.

20. The one or more non-transitory computer-readable media of claim 17, wherein accessing the custodian wallet associated with the person or entity is performed in accordance with a zero-knowledge protocol.
